(19) United States
(12) Patent Application Publication
(10) Pub. No.: US 2026/0085638 A1
(43) Pub. Date: Mar. 26, 2026

(54) COATED COMPONENTS FOR COKE ABATEMENT IN GAS TURBINE ENGINES

(71) Applicant: General Electric Company, Evendale, OH (US)

(72) Inventors: Arundhati Sengupta, Bengaluru (IN); Narayanan Janakiraman, Bengaluru (IN); Karthick Gourishankar, Bengaluru (IN); Sanjay Kumar Sondhi, Bengaluru (IN); Sreerama Prasad Ramaswamy, Bengaluru (IN); Lawrence B. Kool, Clifton Park, NY (US); Byron A. Pritchard, Loveland, OH (US); Kevin H. Janora, Schenectady, NY (US)

(21) Appl. No.: 18/889,990

(22) Filed: Sep. 19, 2024

(30) Foreign Application Priority Data
Mar. 28, 2024 (IN) 202411025309

(51) Int. Cl. F02C 7/30; B01J 23/68; B01J 23/89; B01J 35/00; B01J 35/30; B01J 35/40; B01J 35/45; B01J 37/00; B01J 37/02; B01J 37/03; B01J 37/06; B01J 37/08; B01J 37/34; B08B 17/02; B64D 33/00; F23R 3/40

(52) U.S. Cl. CPC F02C 7/30; B01J 23/681; B01J 23/8913; B01J 23/8953; B01J 35/19; B01J 35/393; B01J 35/395; B01J 35/40; B01J 35/45; B01J 37/009; B01J 37/0244; B01J 37/031; B01J 37/036; B01J 37/06; B01J 37/08; B01J 37/343; B08B 17/02; B64D 33/00; F23R 3/40

(57) ABSTRACT

A coated component for coke abatement in a gas turbine engine. The coated component includes a substrate, and a catalytic coating. The catalytic coating includes a phase enriched in metal oxide and a phase enriched in noble metal. The metal oxide is of formula AₓE_{y}L_{z}MOᵤ where A is one or more alkaline earth elements, x ranges from zero to one, E is one or more alkali metals, y ranges from zero to one, L is one or more lanthanide elements, z ranges from zero to one, M is one or more d-block or p-block elements, O is oxygen, and u ranges from 0.95 to six.

### CROSS REFERENCE TO RELATED APPLICATIONS

The present application claims the benefit of Indian Patent Application number 202411025309, filed on Mar. 28, 2024, which is hereby incorporated by reference herein in its entirety.

### TECHNICAL FIELD

The present disclosure relates to coated components including a substrate and a catalytic coated component, and methods using the coated components for coke abatement, for example, in gas turbine engines for aircraft.

### BACKGROUND

Gas turbine engines include surfaces that contact hydrocarbon fluids, such as fuels and lubricating oils. Carbonaceous deposits (also known as coke) may form on these surfaces when exposed to the hydrocarbon fluids at elevated temperatures, resulting in carbon becoming attached to surfaces contacted by a fuel or oil and building up as deposits on those surfaces contacted by a fuel or oil.

### BRIEF DESCRIPTION OF THE DRAWINGS

Features and advantages of the present disclosure will be apparent from the following description of various exemplary embodiments, as illustrated in the accompanying drawings, wherein like reference numbers generally indicate identical, functionally similar, and/or structurally similar elements.

FIG. 1 is a schematic view of an aircraft having a gas turbine engine according to an embodiment of the present disclosure.

FIG. 2 is a cross-sectional view taken along line 2-2 in FIG. 1, of the gas turbine engine of the aircraft shown in FIG. 2.

FIG. 3 is a cross-sectional view of a combustor of the gas turbine engine shown in FIG. 2 according to an embodiment of the present disclosure. FIG. 3 is a detail view showing detail 3 in FIG. 2.

FIG. 4 is a cross-sectional view of a mixer assembly of the combustor in FIG. 3. FIG. 4 is a detail view showing detail 4 in FIG. 3.

FIG. 5 is a cross-sectional view of a combustor of the gas turbine engine shown in FIG. 2 according to another embodiment of the present disclosure.

FIG. 6 is a cross-sectional view of a mixer assembly of the combustor in FIG. 5. FIG. 6 is a detail view showing detail 6 in FIG. 5.

FIG. 7 is a cross-sectional view of a catalytic coating applied on surfaces of a venturi and an aft heat shield.

FIG. 8A is a cross-sectional view of a catalytic coating applied on a substrate.

FIG. 8B is a cross-sectional view of a catalytic coating applied on a substrate having a ceramic coating.

FIGS. 9A and 9B illustrate a process for forming a catalytic coating on a substrate. FIG. 9A is a cross-sectional view of a metal oxide layer and noble metal layer deposited on the substrate used to form the catalytic coating. FIG. 9B is a cross-sectional view of the catalytic coating on the substrate after heat treating the layers shown in FIG. 9A.

FIGS. 10A and 10B illustrate a process for forming a catalytic coating on a substrate. FIG. 10A is a cross-sectional view of one or more metal oxide layers and noble metal layers deposited on the substrate used to form the catalytic coating. FIG. 10B is a cross-sectional view of the catalytic coating on the substrate after heat treating the layers shown in FIG. 10A.

FIGS. 11A and 11B illustrate a process for forming a catalytic coating on a substrate. FIG. 11A is a cross-sectional view of one or more metal oxide layers and noble metal layers deposited on the substrate used to form the catalytic coating. FIG. 11B is a cross-sectional view of the catalytic coating on the substrate after heat treating the layers shown in FIG. 11A.

FIGS. 12A and 12B illustrate a process for forming a catalytic coating on a substrate. FIG. 12A is a cross-sectional view of one or more metal oxide layers and noble metal layers deposited on the substrate used to form the catalytic coating. FIG. 12B is a cross-sectional view of the catalytic coating on the substrate after heat treating the layers shown in FIG. 12A.

FIGS. 13A and 13B illustrate a process for forming a catalytic coating on a substrate. FIG. 13A is a cross-sectional view of one or more metal oxide layers and noble metal layers deposited on the substrate used to form the catalytic coating. FIG. 13B is a cross-sectional view of the catalytic coating on the substrate after heat treating the layers shown in FIG. 13A.

FIGS. 14A and 14B illustrate a process for forming a catalytic coating on a substrate. FIG. 14A is a cross-sectional view of one or more metal oxide layers and noble metal layers deposited on the substrate used to form the catalytic coating. FIG. 14B is a cross-sectional view of the catalytic coating on the substrate after heat treating the layers shown in FIG. 14A.

FIGS. 15A and 15B illustrate a process for forming a catalytic coating on a substrate. FIG. 15A is a cross-sectional view of a precursor layer deposited on the substrate used to form the catalytic coating. FIG. 15B is a cross-sectional view of the catalytic coating on the substrate after heat treating the precursor layer shown in FIG. 15A.

FIG. 16 is a graph showing carbon mass loss for an example catalytic coating on a substrate.

FIG. 17 is a graph showing carbon mass loss for an example catalytic coating on a substrate.

FIG. 18 is a bar chart showing carbon mass buildup for an example catalytic coating on a substrate and an uncoated control.

FIG. 19 depicts heat flow data for an example catalytic coating.

### DETAILED DESCRIPTION

Features, advantages, and embodiments of the present disclosure are set forth or apparent from a consideration of the following detailed description, drawings, and claims. Moreover, the following detailed description is exemplary and intended to provide further explanation without limiting the scope of the disclosure as claimed.

Various embodiments are discussed in detail below. While specific embodiments are discussed, this is done for illustration purposes only. A person skilled in the relevant art will recognize that other components and configurations may be used without departing the present disclosure.

The terms “forward” and “aft” refer to relative positions within a gas turbine engine or vehicle and refer to the normal operational attitude of the gas turbine engine or vehicle. For example, with regard to a gas turbine engine, forward refers to a position closer to an engine inlet and aft refers to a position closer to an engine nozzle or exhaust.

The terms “upstream” and “downstream” refer to the relative direction with respect to fluid flow in a fluid pathway. For example, “upstream” refers to the direction from which the fluid flows, and “downstream” refers to the direction to which the fluid flows. The term “fluid” may be a gas or a liquid. The term “fluid communication” means that a fluid is capable of making the connection between the areas specified.

The terms “coupled,” “fixed,” “attached,” “connected,” and the like, refer to both direct coupling, fixing, attaching, or connecting as well as indirect coupling, fixing, attaching, or connecting through one or more intermediate components or features, unless otherwise specified herein.

The term “rare earth” refers to elements of groups 3 and 4 of the first, second, and third transition series of the periodic table, e.g., scandium, yttrium, zirconium, and hafnium, and elements of the lanthanide series of the periodic table, e.g., lanthanum, cerium, praseodymium, neodymium, promethium, samarium, europium, gadolinium, terbium, dysprosium, holmium, erbium, thulium, ytterbium, lutetium, and combinations thereof.

The term “alkaline-earth” refers to the elements beryllium (Be), magnesium (Mg), calcium (Ca), strontium (Sr), barium (Ba), radium (Ra), and combinations thereof.

The term “transition metal” refers to the elements of Groups 3 (IIIb) through 12 (IIb) of the periodic table and combinations thereof.

The term “noble metal” refers to the elements rhenium, ruthenium, rhodium, palladium, silver, osmium, iridium, platinum, and gold.

As used herein, an alloy is “based” on a particular element when that element is present in the alloy at the greatest weight percent, by total weight of the alloy, of all elements contained in the alloy. For example, an iron-based alloy has a higher weight percentage of iron than any other single element present in the alloy.

As used herein, a region of a material is a connected subset of the material having an approximately uniform composition.

As used herein, a region in a coating is “enriched” with an element or a compound if the region has a higher concentration of the element or the compound than the coating as a whole.

As used herein, the average crystallite size of a material can be determined by, for example, X-ray diffraction (XRD). The diameter of a crystallite refers to the diameter of the smallest sphere that encloses the crystallite.

As used herein, coke is selectively oxidized by a catalytic coating in the presence of a hydrocarbon fuel if the reaction rate of coke oxidation by the catalytic coating is higher than the rate of consumption of the hydrocarbon fuel by reactions catalyzed by the catalytic coating.

The singular forms “a,” “an,” and “the” include plural references unless the context clearly dictates otherwise.

Approximating language, as used herein throughout the specification and claims, is applied to modify any quantitative representation that could permissibly vary without resulting in a change in the basic function to which it is related. Accordingly, a value modified by a term or terms, such as “about,” “approximately,” and “substantially” is not to be limited to the precise value specified. In at least some instances, the approximating language may correspond to the precision of an instrument for measuring the value, or the precision of the methods or machines for constructing or manufacturing the components and/or systems. For example, the approximating language may refer to being within a one, two, four, ten, fifteen, or twenty percent margin in either individual values, range(s) of values, and/or endpoints defining range(s) of values.

Here and throughout the specification and claims, range limitations may be combined and/or interchanged. Such ranges are identified and include all the sub-ranges contained therein unless context or language indicates otherwise. For example, all ranges disclosed herein are inclusive of the endpoints, and the endpoints are independently combinable with each other.

As noted above, coke deposition may occur on surfaces of a gas turbine engine that are exposed to hydrocarbon fluids, such as fuels and lubricating oils, at elevated temperatures. The fuel nozzle and swirler (collectively, a mixer assembly) used in a combustor for a gas turbine engine includes such surfaces. The fuel nozzle aft heat shield (FN-AHS) protects the fuel nozzle from hot combustion gases during engine operation. Surfaces of the FN-AHS and other surfaces of the mixer assembly are exposed to hydrocarbon fluids, such as fuel, and operation of the gas turbine engine, particularly, continuous operation at cruise for aircraft gas turbine engines, can result in significant build-up of coke and/or partially burned fuel deposits on exposed surfaces of the FN-AHS and the mixer assembly.

Coke can build up in considerable thickness, and large pieces of coke can shed off these surfaces, becoming internal domestic objects that can cause significant damage to components downstream of the fuel nozzle (hot gas path components). Some of these components have thermal barrier coatings (TBCs). The resulting internal domestic object impact damage (DoD) may result in spallation of the thermal barrier coating and may reduce the durability of components such as combustors, nozzles, shrouds, and airfoils. The coke deposits can be reduced or eliminated using a catalytic coating capable of catalyzing a degradation reaction of coke such as, for example, coke oxidation. For example, coke oxidation may convert solid coke deposits to gaseous reaction products because coke oxidation may include the reaction of carbon with diatomic oxygen to form reaction products such as carbon monoxide and carbon dioxide. Without a catalytic coating capable of catalyzing a degradation reaction of coke, coke may build up on a surface and degrade the performance of systems and components. For example, the catalytic coating may reduce coking at low temperatures, as discussed below, and may be useful for reducing coking on fuel nozzles and valves as described in more detail below.

Disclosed herein are catalytic coatings that can be applied to various surfaces and components to reduce the buildup of coke thereon. The catalytic coatings include a metal oxide enriched region and a noble metal enriched region such that the catalytic coating is catalytically active. Crystallite sizes of the metal oxide enriched region and the noble metal enriched region are tailored to improve, for example, catalytic activity of the catalytic coatings when the catalytic coating is applied to a substrate such as a surface or a portion of a component. Some non-limiting examples of suitable surfaces and components include aircraft components, gas turbine engine components, lube oil system components, and fuel passage components, fuel circuit components, fuel nozzles (e.g., a venturi surface on the fuel nozzle), mixer assembly components, a heat exchanger, and aft heat shields. The gas turbine may be a gas turbine for an aircraft or may be a terrestrial turbine such as for a power plant, or a maritime gas turbine engine for a ship. Some such components are described in more detail below.

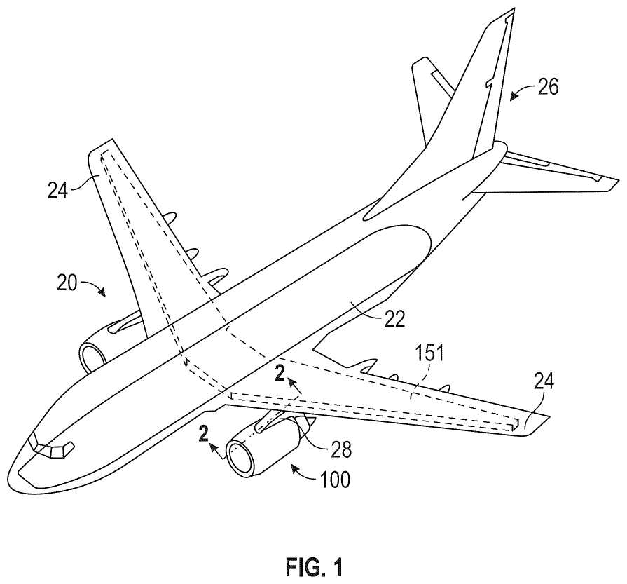

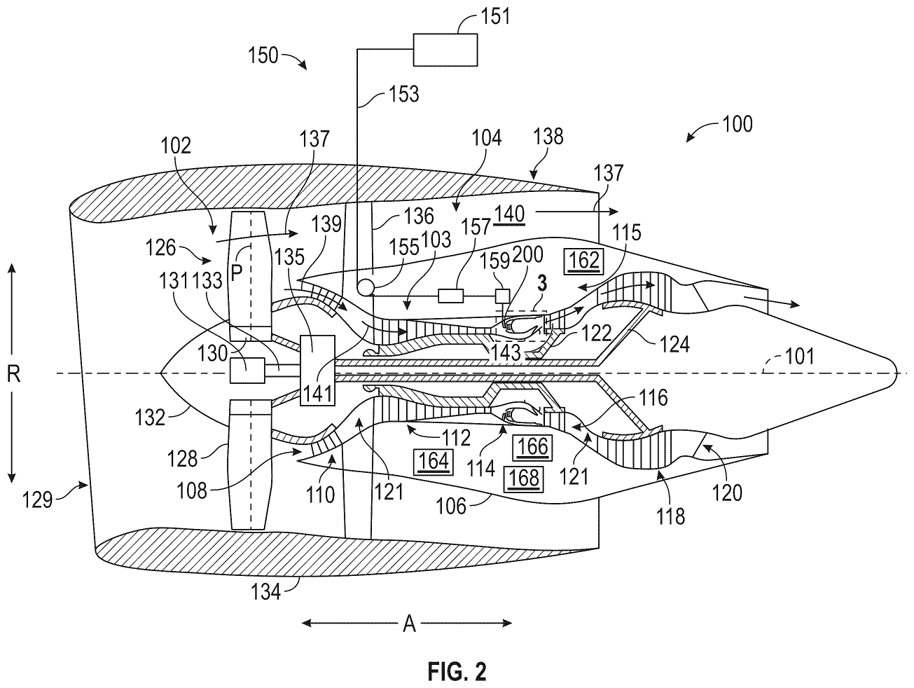

FIG. 1 shows an aircraft 20 that may implement various embodiments. The aircraft 20 includes a fuselage 22, wings 24 attached to the fuselage 22, and an empennage 26. The aircraft 20 also includes a propulsion system that produces a propulsive thrust required to propel the aircraft 20 in flight, during taxiing operations, and the like. The propulsion system for the aircraft 20 shown in FIG. 2 includes a pair of engines 100. In this embodiment, each engine 100 is attached to one of the wings 24 by a pylon 28 in an under-wing configuration. Although the engines 100 are shown attached to the wing 24 in an under-wing configuration in FIG. 2, in other embodiments, the engine 100 may have alternative configurations and be coupled to other portions of the aircraft 20. For example, the engine 100 may additionally or alternatively include one or more aspects coupled to other parts of the aircraft 20, such as, for example, the empennage 26, and the fuselage 22.

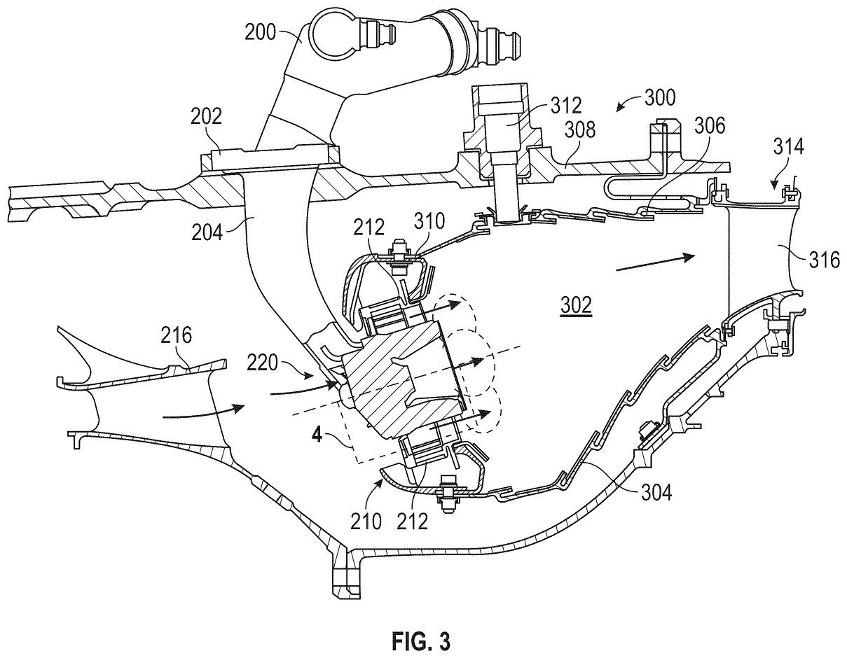

As will be described further below, with reference to FIG. 2, the engines 100 shown in FIG. 1 are gas turbine engines that are each capable of selectively generating a propulsive thrust for the aircraft 20. The amount of propulsive thrust may be controlled at least in part based on a volume of fuel provided to the engine 100 (e.g., a gas turbine engine) via a fuel system 150 (see FIG. 3). An aviation turbine fuel in the embodiments discussed herein is a combustible hydrocarbon liquid fuel, such as a kerosene-type fuel, having a desired carbon number, a synthetic aviation fuel, a biofuel, a biodiesel, an ethanol, a bioalcohol, and the like. The fuel is stored in a fuel tank 151 of the fuel system 150. As shown in FIG. 2, at least a portion of the fuel tank 151 is located in each wing 24 and a portion of the fuel tank 151 is located in the fuselage 22 between the wings 24. The fuel tank 151, however, may be located at other suitable locations in the fuselage 22 or the wing 24. The fuel tank 151 may also be located entirely within the fuselage 22 or the wing 24. The fuel tank 151 may also be separate tanks instead of a single, unitary body, such as, for example, two tanks each located within a corresponding wing 24.

Although the aircraft 20 shown in FIG. 1 is an airplane, the embodiments described herein may also be applicable to other aircraft 20, including, for example, helicopters and unmanned aerial vehicles (UAV). The aircraft discussed herein are fixed-wing aircraft or rotor aircraft that generate lift by aerodynamic forces acting on, for example, a fixed wing (e.g., the wing 24) or a rotary wing (e.g., a rotor of a helicopter), and are heavier-than-air aircraft, as opposed to lighter-than-air aircraft (such as a dirigible). Further, although not depicted herein, in other embodiments, the gas turbine engine may be any other suitable type of gas turbine engine, such as an industrial gas turbine engine incorporated into a power generation system, a nautical gas turbine engine, etc.

FIG. 2 is a schematic, cross-sectional view of one of the engines 100 used in the propulsion system for the aircraft 20 shown in FIG. 1. The cross-sectional view of FIG. 2 is taken along line 2-2 in FIG. 1. For the embodiment depicted in FIG. 2, the engine 100 is a high bypass engine. The engine 100 has an axial direction A (extending parallel to a longitudinal centerline axis 101, shown for reference in FIG. 2), a radial direction R, and a circumferential direction. The circumferential direction (not depicted in FIG. 2) extends in a direction rotating about the axial direction A. The engine 100 includes a fan section 102 and a turbo-engine 104 disposed downstream from the fan section 102.

The turbo-engine 104 depicted in FIG. 2 includes, in serial flow relationship, a compressor section 103, a combustion section 114, and a turbine section 115. The turbo-engine 104 is substantially enclosed within an outer casing 106 that is substantially tubular and defines a core inlet 108. The core inlet 108 is annular in the depicted embodiment. As schematically shown in FIG. 2, the compressor section 103 includes a booster or a low pressure (LP) compressor 110 followed downstream by a high pressure (HP) compressor 112. The combustion section 114 is downstream of the compressor section 103. The turbine section 115 is downstream of the combustion section 114 and includes a high pressure (HP) turbine 116 followed downstream by a low pressure (LP) turbine 118. The turbo-engine 104 further includes a jet exhaust nozzle section 120 that is downstream of the turbine section 115, a high-pressure (HP) shaft 122 or a spool, and a low-pressure (LP) shaft 124. The HP shaft 122 drivingly connects the HP turbine 116 to the HP compressor 112. The HP turbine 116 and the HP compressor 112 rotate in unison through the HP shaft 122. The LP shaft 124 drivingly connects the LP turbine 118 to the LP compressor 110. The LP turbine 118 and the LP compressor 110 rotate in unison through the LP shaft 124. The compressor section 103, the combustion section 114, the turbine section 115, and the jet exhaust nozzle section 120 together define a core air flow path 121 through which core air 139 flows.

The fan section 102 shown in FIG. 2 includes a fan 126 (e.g., a variable pitch fan) having a plurality of fan blades 128 coupled to a disk 130 in a spaced apart manner. As depicted in FIG. 2, the fan blades 128 extend outwardly from the disk 130 generally along the radial direction R. In the case of a variable pitch fan, the plurality of fan blades 128 are rotatable relative to the disk 130 about a pitch axis P by virtue of the fan blades 128 being operatively coupled to an actuation member 131 configured to collectively vary the pitch of the fan blades 128 in unison. The fan blades 128, the disk 130, and the actuation member 131 are together rotatable about the longitudinal centerline axis 101 via a fan shaft 133 that is powered by the LP shaft 124 across a power gearbox, also referred to as a gearbox assembly 135. In this way, the fan 126 is drivingly coupled to, and powered by, the turbo-engine 104, and the engine 100 is an indirect drive engine. The gearbox assembly 135 is shown schematically in FIG. 3. The gearbox assembly 135 may be a reduction gearbox assembly for adjusting the rotational speed of the fan shaft 133 and, thus, the fan 126 relative to the LP shaft 124 when power is transferred from the LP shaft 124 to the fan shaft 133.

Referring still to the exemplary embodiment of FIG. 2, the disk 130 is covered by a fan hub 132 that is aerodynamically contoured to promote an airflow through the plurality of fan blades 128. In addition, the fan section 102 includes an annular fan casing or a nacelle 134 that circumferentially surrounds the fan 126 and at least a portion of the turbo-engine 104. The nacelle 134 is supported relative to the turbo-engine 104 by a plurality of outlet guide vanes 136 that are circumferentially spaced about the nacelle 134 and the turbo-engine 104. Moreover, a downstream section 138 of the nacelle 134 extends over an outer portion of the turbo-engine 104, and, with the outer casing 106, defines a bypass airflow passage 140 therebetween.

During operation of the engine 100, a volume of air enters the turbine engine (e.g., engine 100) through an engine inlet 129 of the nacelle 134 or the fan section 102. As the volume of air passes across the fan blades 128, a first portion of air, also referred to as bypass air 137, is routed into the bypass airflow passage 140, and a second portion of air, also referred to as core air 139, is routed into the upstream section of the core air flow path 121 through the core inlet 108 of the LP compressor 110. The ratio between the bypass air 137 and the core air 139 is commonly known as a bypass ratio. The pressure of the core air 139 is then increased in the compressor section 103 and, more specifically, the LP compressor 110, generating compressed air 141. The compressed air 141 is routed through the HP compressor 112, where the compressed air 141 is further compressed, and into the combustion section 114, where the compressed air 141 is mixed with fuel and ignited to generate combustion gases 143.

The combustion gases 143 are routed into the HP turbine 116 and expanded through the HP turbine 116 where a portion of thermal energy or kinetic energy from the combustion gases 143 is extracted via one or more stages of HP turbine stator vanes and HP turbine rotor blades that are coupled to the HP shaft 122. This causes the HP shaft 122 to rotate, thereby supporting operation of the HP compressor 112 (self-sustaining cycle). In this way, the combustion gases 143 do work on the HP turbine 116. The combustion gases 143 are then routed into the LP turbine 118 and expanded through the LP turbine 118. Here, a second portion of the thermal energy or the kinetic energy is extracted from the combustion gases 143 via one or more stages of LP turbine stator vanes and LP turbine rotor blades that are coupled to the LP shaft 124. This causes the LP shaft 124 to rotate, thereby supporting operation of the LP compressor 110 (self-sustaining cycle) and rotation of the fan 126 via the gearbox assembly 135. In this way, the combustion gases 143 do work on the LP turbine 118.

The combustion gases 143 are subsequently routed through the jet exhaust nozzle section 120 of the turbo-engine 104 to provide propulsive thrust. Simultaneously, the bypass air 137 is routed through the bypass airflow passage 140 before being exhausted from a fan nozzle exhaust section of the engine 100, also providing propulsive thrust. The HP turbine 116, the LP turbine 118, and the jet exhaust nozzle section 120 at least partially define a hot gas path for routing the combustion gases 143 through the turbo-engine 104.

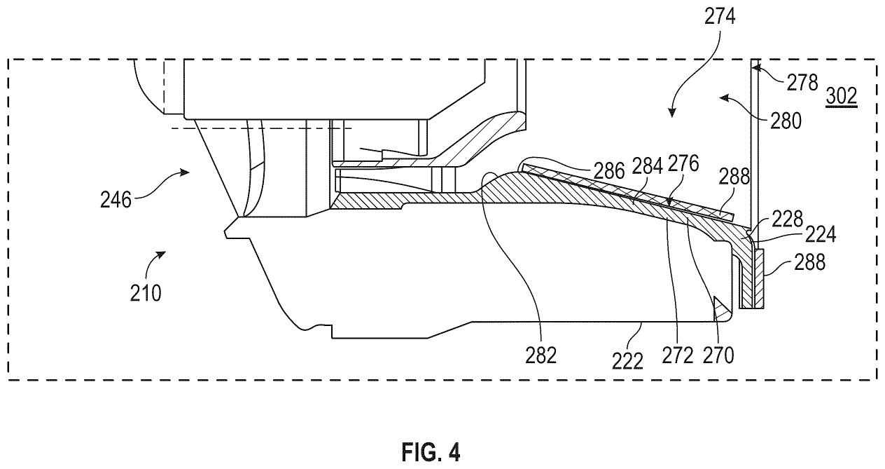

The engine 100 is operable with the fuel system 150 and receives a flow of fuel from the fuel system 150. The fuel system 150 includes a fuel delivery assembly 153 providing the fuel flow from the fuel tank 151 to the engine 100, and, more specifically, to a plurality of fuel injectors 200 that inject fuel into a combustion chamber 302 of a combustor 300 (see FIG. 4, discussed further below) of the combustion section 114.

The components of the fuel system 150, and, more specifically, the fuel tank 151, is an example of a fuel source that provides fuel to the fuel injectors 200, as discussed in more detail below. The fuel delivery assembly 153 includes tubes, pipes, conduits, and the like, to fluidly connect the various components of the fuel system 150 to the engine 100. The fuel tank 151 is configured to store the hydrocarbon fuel, and the hydrocarbon fuel is supplied from the fuel tank 151 to the fuel delivery assembly 153. The fuel delivery assembly 153 is configured to carry the hydrocarbon fuel between the fuel tank 151 and the engine 100 and, thus, provides a flow path (fluid pathway) of the hydrocarbon fuel from the fuel tank 151 to the engine 100.

The fuel system 150 includes at least one fuel pump fluidly connected to the fuel delivery assembly 153 to induce the flow of the fuel through the fuel delivery assembly 153 to the engine 100. One such pump is a main fuel pump 155. The main fuel pump 155 is a high-pressure pump that is the primary source of pressure rise in the fuel delivery assembly 153 between the fuel tank 151 and the engine 100. The main fuel pump 155 may be configured to increase a pressure in the fuel delivery assembly 153 to a pressure greater than a pressure within a combustion chamber 302 of the combustor 300.

The fuel system 150 also includes a fuel metering unit 157 in fluid communication with the fuel delivery assembly 153. Any suitable fuel metering unit 157 may be used including, for example, a metering valve. The fuel metering unit 157 is positioned downstream of the main fuel pump 155 and upstream of a fuel manifold 159 configured to distribute fuel to the fuel injectors 200. The fuel system 150 is configured to provide the fuel to the fuel metering unit 157, and the fuel metering unit 157 is configured to receive fuel from the fuel tank 151. The fuel metering unit 157 is further configured to provide a flow of fuel to the engine 100 in a desired manner. More specifically, the fuel metering unit 157 is configured to meter the fuel and to provide a desired volume of fuel, at, for example, a desired flow rate, to the fuel manifold 159 of the engine 100. The fuel manifold 159 is fluidly connected to the fuel injectors 200 and distributes (provides) the fuel received to the plurality of fuel injectors 200, where the fuel is injected into the combustion chamber 302 and combusted. Adjusting the fuel metering unit 157 changes the volume of fuel provided to the combustion chamber 302 and, thus, changes the amount of propulsive thrust produced by the engine 100 to propel the aircraft 20.

The engine 100 also includes various accessory systems to aid in the operation of the engine 100 and/or an aircraft that includes the engine 100. For example, the engine 100 may include a main lubrication system 162, a compressor cooling air (CCA) system 164, an active thermal clearance control (ATCC) system 166, and a generator lubrication system 168, each of which is depicted schematically in FIG. 2. The main lubrication system 162 is configured to provide a lubricant to, for example, various bearings and gear meshes in the compressor section, the turbine section, the HP shaft 122, and the LP shaft 124. The lubricant provided by the main lubrication system 162 may increase the useful life of such components and may remove a certain amount of heat from such components through the use of one or more heat exchangers. The compressor cooling air (CCA) system 164 provides air from one or both of the HP compressor 112 or the LP compressor 110 to one or both of the HP turbine 116 or the LP turbine 118. The active thermal clearance control (ATCC) system 166 acts to minimize a clearance between tips of turbine blades and casing walls as casing temperatures vary during a flight mission. The generator lubrication system 168 provides lubrication to an electronic generator (not shown), as well as cooling/heat removal for the electronic generator. The electronic generator may provide electrical power to, for example, a startup electrical motor for the engine 100 and/or various other electronic components of the engine 100 and/or an aircraft including the engine 100. The lubrication systems for the engine 100 (e.g., the main lubrication system 162 and the generator lubrication system 168) may use hydrocarbon fluids, such as oil, for lubrication, in which the oil circulates through inner surfaces of oil scavenge lines.

The engine 100 discussed herein is provided by way of example only. In other embodiments, any other suitable engine may be utilized with aspects of the present disclosure. For example, in other embodiments, the engine may be any other suitable gas turbine engine, such as a turboshaft engine, a turboprop engine, a turbojet engine, an unducted single fan engine, and the like. In such a manner, in other embodiments, the gas turbine engine may have other suitable configurations, such as, direct drive configurations, fixed pitch fans, or other suitable numbers or arrangements of shafts, compressors, turbines, fans, etc. Further, although a particular engine 100 is depicted in FIG. 2, the catalytic coatings disclosed herein may be used more generally and/or with other engine embodiments. For example, in alternative embodiments, aspects of the present disclosure may be incorporated into, or otherwise utilized with any other type of engine, such as reciprocating engines. Additionally, in still other exemplary embodiments, the exemplary engine 100 may include or be operably connected to any other suitable accessory systems. Additionally, or alternatively, the exemplary engine 100 may not include or be operably connected to one or more of the accessory systems 162, 164, 166, and 168, discussed above.

FIG. 3 shows a combustor 300 of the combustion section 114 (FIG. 2) according to an embodiment of the present disclosure. FIG. 3 is a detail view showing detail 3 in FIG. 2. The combustor 300 is an annular combustor that includes a combustion chamber 302 defined between an inner liner 304 and an outer liner 306. Each of the inner liner 304 and the outer liner 306 is annular about the longitudinal centerline axis 101 of the engine 100 (FIG. 2). The combustor 300 also includes a combustor case 308 that is also annular about the longitudinal centerline axis 101 of the engine 100. The combustor case 308 extends circumferentially around the inner liner 304 and the outer liner 306, and the inner liner 304 and the outer liner 306 are located radially inward of the combustor case 308. The combustor 300 also includes a dome 310 mounted to a forward end of each of the inner liner 304 and the outer liner 306. The dome 310 defines an upstream (or forward end) of the combustion chamber 302.

A plurality of mixer assemblies 210 (only one is illustrated in FIG. 3) are spaced around the dome 310. The plurality of mixer assemblies 210 are circumferentially spaced about the longitudinal centerline axis 101 of the engine 100. In the embodiment shown in FIG. 3, each mixer assembly 210 is a twin annular premixing swirler (TAPS) that includes a main mixer 212 and a pilot mixer (not shown). The pilot mixer is supplied with fuel from the fuel injector 200 during the entire engine operating cycle, and the main mixer 212 is supplied with fuel from the fuel injector 200 only during increased power conditions of the engine operating cycle, such as take-off and climb, for example. The TAPS mixer assembly 210 is provided by way of example and the catalytic coating discussed herein may be applied to other mixer assembly designs and other combustor designs.

As noted above, the compressor section, including the HP compressor 112 (FIG. 2), pressurizes air, and the combustor 300 receives an annular stream of this pressurized air from a discharge outlet (compressor discharge outlet 216) of the HP compressor 112. This air may be referred to as compressor discharge pressure air. A portion of the compressor discharge air flows into the mixer assembly 210. Fuel is injected into the air in the mixer assembly 210 to mix with the air and to form a fuel-air mixture. The fuel-air mixture is provided to the combustion chamber 302 from the mixer assembly 210 for combustion. Ignition of the fuel-air mixture is accomplished by an igniter 312, and the resulting combustion gases flow in an axial direction toward and into an annular, first stage turbine nozzle 314. The first stage turbine nozzle 314 is defined by an annular flow channel that includes a plurality of radially extending, circularly-spaced nozzle vanes 316 that turn the gases so that they flow angularly and impinge upon the first stage turbine blades (not shown) of a first turbine (not shown) of the HP turbine 116 (FIG. 2).

The fuel injector 200 is fixed to the combustor case 308 by a nozzle mount. In this embodiment, the nozzle mount is a flange 202 that is integrally formed with a stem 204 of the fuel injector 200. The flange 202 is fixed to the combustor case 308 and sealed to the combustor case 308. The stem 204 includes a flow passage through which the hydrocarbon fuel flows, and the stem 204 extends radially inward from the flange 202. The fuel injector 200 also includes a fuel nozzle tip 220 through which fuel is injected into the combustion chamber 302 as part of the mixer assembly 210.

FIG. 4 shows the mixer assembly 210 of the combustor 300 shown in FIG. 3. FIG. 4 is a detail view showing detail 4 in FIG. 3, and, as FIG. 3 is a cross-sectional view, FIG. 4 is also a cross-sectional view of the mixer assembly 210. The fuel nozzle tip 220 (FIG. 3) includes a fuel nozzle body 222 and an aft heat shield 224 attached to the fuel nozzle body 222. The fuel nozzle body 222 may be mounted to, e.g., an inlet fairing. The inlet fairing is connected to or integral with the stem 204 (FIG. 3). The fuel nozzle body 222 may include, for example, a main fuel nozzle and a dual orifice pilot fuel injector tip having a primary pilot fuel orifice and a secondary pilot fuel orifice. The primary pilot fuel orifice and the secondary pilot fuel orifice may be substantially concentric with each other and substantially centered in an annular pilot inlet 246. The main fuel nozzle surrounds the pilot inlet 246, and the pilot inlet 246 is located between the main fuel nozzle and the dual orifice pilot fuel injector tip. In this embodiment, the fuel nozzle tip 220 (see FIG. 3) is circular about an axis extending through the center of the primary pilot fuel orifice. In the discussion below, various features of the fuel nozzle tip 220 may be discussed relative to this axis. Fuel is provided through the stem 204 to the main fuel nozzle. The main fuel nozzle can inject fuel in a radially outward direction through a circular array of main fuel injection orifices formed on an outer surface of the fuel nozzle body 222. Fuel is also provided through the stem 204 to the primary pilot fuel orifice and the secondary pilot fuel orifice. The pilot mixer is supported by an annular pilot housing 270.

The pilot mixer is supported by an annular pilot housing 270. The pilot housing 270 includes a conical wall section 272 circumscribing a conical pilot mixing chamber 274 that is in flow communication with, and downstream from, the pilot mixer, and, more specifically, the outlet. The pilot mixing chamber 274 is also fluidly connected to the primary pilot fuel orifice and the secondary pilot fuel orifice, and downstream of the primary pilot fuel orifice and the secondary pilot fuel orifice. The pilot mixing chamber 274 is a passage of the fuel injector 200 and, more specifically, the fuel nozzle tip 220. As the fuel nozzle tip 220 is also a portion of the mixer assembly 210, the pilot mixing chamber 274 also is a passage of the mixer assembly 210.

The conical wall section 272 of the pilot housing 270 is thus a passage wall that includes a passage wall surface 276 facing the pilot mixing chamber 274 (passage). In this embodiment, the conical wall section 272 is part of a second venturi 280 formed by the pilot housing 270. The second venturi 280 includes a converging section 282, a diverging section 284, and a throat 286 between the converging section 282 and the diverging section 284. The diverging section 284 is provided by the conical wall section 272, which extends downstream from the throat 286 and continues with exposed surfaces 228 of the aft heat shield 224. The exposed surfaces 228 of this embodiment form a conical wall section of the aft heat shield 224 that is coplanar with the wall surface 276 of the conical wall section 272. Diverging section 284 has an upstream end, which, in this embodiment, is the throat 286 and a downstream end, which, in this embodiment, is an outlet 278 of the pilot mixing chamber 274. As can be seen in FIG. 4, the cross-sectional area of the second venturi 280 at the outlet 278 (the downstream end) is greater than the cross-sectional area of the second venturi 280 at the throat 286 (the upstream end).

Air flows through the outer pilot swirler through the converging section 282 toward the throat 286. This air is mixed with the fuel-air mixture from the outlet and moves through the throat 286 to the diverging section 284 and the aft heat shield 224. The pilot mixing chamber 274 and, more specifically, the wall surface 276 of the conical wall section 272 are exposed to hydrocarbon fuel as the fuel-air mixture flows through the pilot mixing chamber 274, through the outlet 278 of the pilot mixing chamber 274, and into the combustion chamber 302. Being adjacent to the combustion chamber 302 and adjacent to the primary combustion zone, the fuel, the conical wall section 272, and the aft heat shield 224 are exposed to high temperatures. For example, the conical wall section 272 and the aft heat shield 224 may be at temperatures from three hundred degrees Celsius to six hundred degrees Celsius and from six hundred degrees Celsius to one thousand four hundred degrees Celsius, respectively.

The pilot housing 270 and the aft heat shield 224 are made from materials suitable for use in these high temperature environments including, for example, stainless steel, corrosion-resistant alloys of nickel and chromium, and high-strength nickel-base alloys. The pilot housing 270 and the aft heat shield 224 may thus be formed from a metal alloy chosen from the group consisting of iron-based alloys, nickel-based alloys, cobalt-based alloys, and chromium-based alloys. Exposed surfaces of these materials at these temperatures, and, more particularly, the wall surface 276 may thus be susceptible to a significant build-up of coke and/or partially burned fuel deposits. The coke forming on such materials may be strongly bound to these metallic components of the fuel nozzle tip 220 leading to the formation of a thick layer of coke, e.g., coke with large particles, polymeric coke, and/or autoxidation coke. As noted above, coke can build up in considerable thickness on these surfaces and large pieces of coke can shed off, becoming internal domestic objects that can cause significant damage to components downstream of the fuel nozzle (hot gas path components).

To prevent the build-up of coke and the issues discussed above, at least a portion of the surfaces of the second venturi 280, including, for example, the wall surface 276 and the aft heat shield 224 may be coated with a catalytic coating 288 to inhibit coke deposition and build-up. As noted above, the pilot mixing chamber 274 is a passage, and, in embodiments discussed herein, a portion of the wall of the passage is a coated passage wall that is coated with the catalytic coating 288. The coated passage wall is located downstream of the fuel injection port (the primary pilot fuel orifice and the secondary pilot fuel orifice, in this embodiment). As noted above, air flows through the pilot mixing chamber 274 (passage) and is introduced by an air inlet. In these embodiments, the air inlet is upstream of the coated passage wall. More specifically, air is introduced into the pilot mixing chamber 274 (passage) by the pilot inlet 246, through the inner pilot swirler and the outer pilot swirler. The air flowing through the inner pilot swirler is also introduced to the pilot mixing chamber 274 via outlet.

Exposed surfaces of the underlying (base) material of the pilot housing 270, and, more specifically, the conical wall section 272 or the aft heat shield 224, promote the formation of thick, large grains of coke, and the catalytic coating 288 of this embodiment is applied as a continuous layer on the wall surface 276 to avoid discontinuities that would expose the base material. Depending on the application region, the thickness of the catalytic coating 288 can be suitably determined to account for, for example, the coke buildup rate, catalyst wear rate, etc. For example, the thickness of the catalytic coating 288 can range from twenty nanometers to ten microns. In some embodiments, twenty nanometers to three microns can be applied by certain methods such as chemical bath deposition (CBD), sol-gel or dip-coating in a sol, chemical vapor deposition (CVD) and/or electrodeposition. Such thickness may be suitable for narrow inner diameter (e.g., 0.3 to 0.8 mm) fuel/oil circuits, for example in a main orifice or a valve region in an aircraft engine fuel nozzle. Higher thicknesses can be applied by spraying catalyst powder slurry formulated with a suitable binder and solvent onto the desired surface which could be the internal surfaces of tubes/venturi having wider inner diameters and potentially higher coke deposition rates than surfaces mentioned above.

The catalytic coating 288 may have a thickness of, for example, less than two hundred microns, such as less than one hundred microns, less than ten microns, less than five microns, or less than two microns. In some embodiments, the thickness of the catalytic coating 288 may be from one micron to two hundred microns. In other embodiments, the catalytic coating 288 may have a thickness of, for example, less than three hundred nanometers such as less than one hundred nanometers. In some embodiments, the thickness of the catalytic coating 288 may be from twenty nanometers to three hundred nanometers. In some embodiments, the thickness of the catalytic coating 288 may be from three hundred nanometers to ten microns.

The catalytic coating 288 may have a smooth surface finish having a surface roughness Ra ranging from 0.01 micron to 0.4 micron. A smooth surface finish may also help to prevent coke from sticking to the second venturi 280. In some embodiments, the catalytic coating 288 may have a surface finish having a surface roughness Ra from five microns to ten microns when deposited using, for example, an air plasma spray and, in other embodiments, from 0.5 micron to 1.5 micron when deposited using, for example, electron beam physical vapor deposition. Other techniques of catalytic coating deposition may include slurry spray, suspension plasma spray, and solution precursor plasma spray, all of which may have a surface finish having a surface roughness Ra ranging from 0.5 micron to ten microns. In some embodiments, the coatings are conformal and thin and therefore show the same surface roughness as of the underlying substrate. For example, conformal coatings may be applicable to surfaces having a roughness Ra value ranging from four microns to fifteen microns.

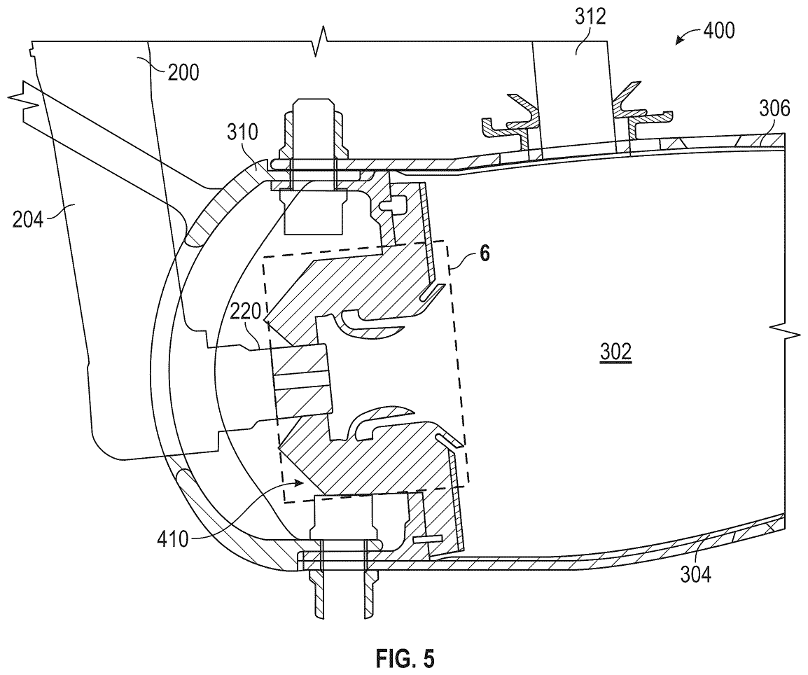

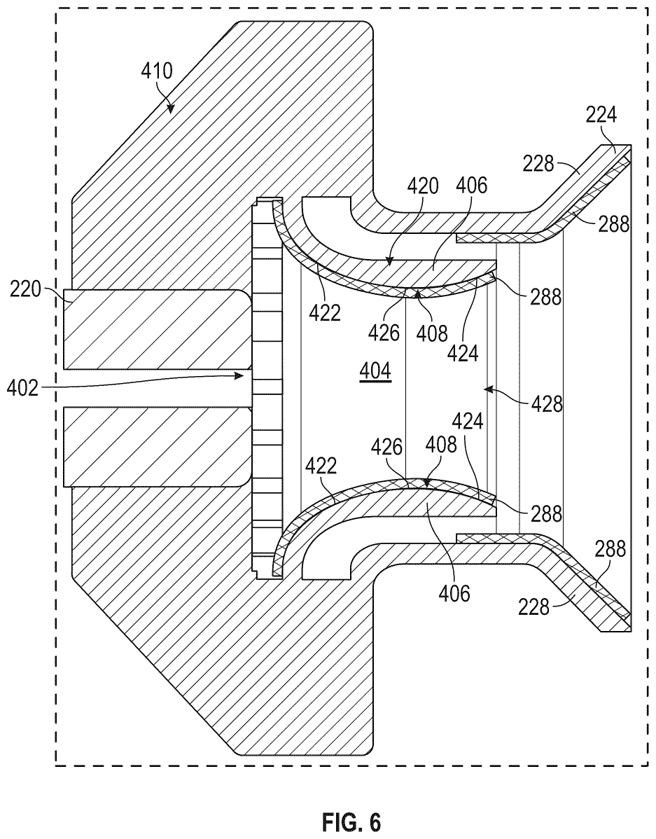

In the preceding discussion, the combustor 300 and the mixer assembly 210 were configured to use a twin annular premixing swirler (TAPS), but the catalytic coating 288 discussed herein may be applied to other mixer assembly designs and other combustor designs. Another example of a combustor 400 is shown in FIG. 5. FIG. 5 is a cross-sectional view of the combustor 400 showing a rich burn combustor design. FIG. 6 shows a mixer assembly 410 of the combustor 400 shown in FIG. 5. FIG. 6 is a detail view showing detail 6 in FIG. 5, and, as FIG. 5 is a cross-sectional view, FIG. 6 is also a cross-sectional view of the mixer assembly 410. The combustor 400 and the mixer assembly 410 of this embodiment include the same or similar components as the combustor 300 and the mixer assembly 210 discussed above. Components in this embodiment that are the same or similar to those discussed above are identified with the same reference numeral and a detailed description of these components is omitted.

The combustor 400 of this embodiment shows a rich burn combustor. A plurality of mixer assemblies 410 (only one is illustrated) are spaced around the dome 310. Fuel is injected into the mixer assembly 410 by a fuel injection port 402. The fuel injection port 402 injects fuel in a generally downstream direction and into the compressed air flowing through a first swirler (not shown). The fuel is injected into a mixing chamber 404 that mixes the fuel with the compressed air to form a fuel-air mixture. As with the pilot mixing chamber 274 discussed above, the mixing chamber 404 of this embodiment is a passage of the fuel injector 200 with a wall section 406 that includes a passage wall surface 408 facing the mixing chamber 404 (passage). In this embodiment, wall section 406 is part of a venturi 420 that includes a converging section 422, a diverging section 424, and a throat 426 between the converging section 422 and the diverging section 424. In this embodiment, the catalytic coating 288 is formed on the surfaces of the venturi 420. The fuel-air mixture exits through an outlet 428 of the mixing chamber 404 and is combined with air flowing through a second swirler (not shown) at a position upstream of the exposed surfaces 228 of the aft heat shield 224. In this embodiment, the catalytic coating 288 is also formed on the exposed surface 228 of the aft heat shield 224.

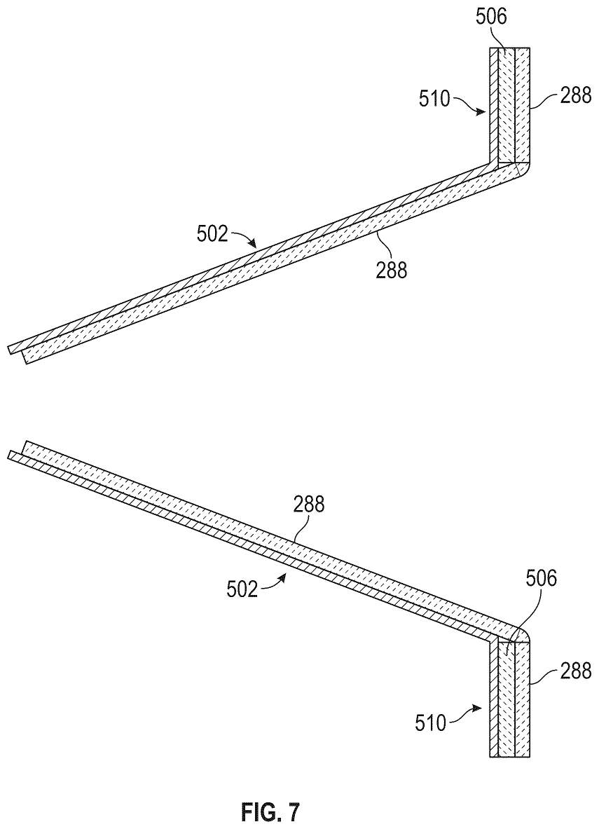

As discussed above, the catalytic coating 288 can be applied to a venturi component (e.g., venturi 280 or venturi 420). For example, the catalytic coating 288 can be applied directly to a surface of a venturi wall 502, as depicted in FIG. 7. Additionally, or alternatively, the catalytic coating 288 can be applied to the surface of the TBC 506, which exists on the surface of the AHS 510. The description of such components above applies here.

The preceding discussion is by way of example only and the catalytic coating may be applied to any substrate such as a metal substrate, a ceramic substrate, a metal substrate coated with a ceramic layer, or a ceramic substrate coated with a metal layer.

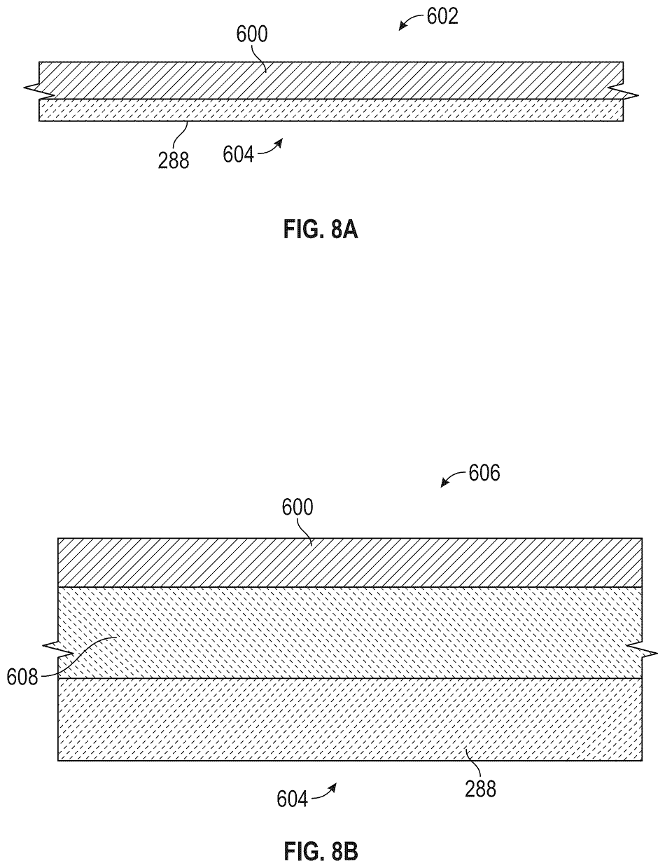

FIG. 8A depicts a catalytic coating 288 on a generic substrate 600. The generic substrate 600 may be a metal substrate, a ceramic substrate, a metal substrate coated with a ceramic layer, or a ceramic substrate coated with a metal layer. The generic substrate 600 may be a portion of a component 602 such as a component that is positioned or otherwise arranged to come into contact with, for example, a hydrocarbon fluid, such as fuel, oil, and the like, as discussed above, and the catalytic coating 288 may be applied to surface of the substrate facing the hydrocarbon fluid, such as a surface facing or otherwise defining a passage 604 for the hydrocarbon fluid to flow therethrough.

FIG. 8B also depicts the catalytic coating 288 on the generic substrate 600. A component 606 depicted in FIG. 8B is similar to the component 602 depicted in FIG. 8A. In some applications, the generic substrate 600 may be a metal and may have a ceramic coating 608 (such as a thermal barrier coating (TBC)) on the metal substrate. As discussed further herein, the catalytic coating 288 may be applied as a coating on top of the TBC, as depicted in FIG. 8A, or be integrated within the TBC. Example materials for TBCs include yttria-stabilized zirconia (YSZ such as 8 YSZ, 20 YSZ, 55 YSZ), La—Gd-Zirconate, La—Yb-Zirconate, La—Gd—Yb-Zirconate, rare-earth-Ta-Zirconate, rare-earth-Nb-Zirconate, and (ZrO₂)_{(1-q)}(Y₂O₃) q wherein q ranges from 0.04 to 0.5. The metal substrates may include, for example, iron-based alloys, nickel-based alloys, cobalt-based alloys, alloys containing cobalt and chromium, alloys containing platinum and aluminum, alloys containing nickel and aluminum, or alloys containing nickel, chromium, aluminum, and yttrium.

The catalytic coating may be applied to a substrate with various thickness. Depending on the application, the thickness of the catalytic coating can be suitably determined to account for, for example, the coke buildup rate, catalytic coating wear rate, etc. The catalytic coating may have a thickness of, for example, less than two hundred microns, less than one hundred microns, less than ten microns, or less than two microns. In some embodiments, the thickness of the catalytic coating may be from 0.1 micron to two microns. In some embodiments, the thickness of the catalytic coating may be from twenty nanometers to three hundred nanometers. In some embodiments, the thickness of the catalytic coating may be from twenty nanometers to two microns.

The catalytic coating can be applied to a substrate by using various techniques. For example, the catalytic coating can be applied by sol-gel deposition, solution deposition, chemical bath deposition, chemical vapor deposition, atomic layer deposition, electrochemical deposition, and/or sputter deposition techniques (e.g., on roughness-modified surfaces).

The catalytic coating can be applied in one or more layers. For example, a method of making a coated component includes at least one metal oxide depositing step where the metal oxide of formula AₓE_{y}L_{z}MOᵤ is deposited as a metal oxide layer. The method may further include at least one noble metal depositing step where the noble metal is deposited as a noble metal layer. The method may further include a heating step at a temperature ranging from five hundred degrees Fahrenheit to two thousand degrees Fahrenheit or a temperature ranging from three hundred degrees Fahrenheit to one thousand seven hundred degrees Fahrenheit where the heating step occurs after the at least one metal oxide depositing step and after the at least one noble metal depositing step. In some embodiments of the method, one of the at least one noble metal depositing step deposits the noble metal on the substrate or one of the at least one metal oxide depositing step deposits the metal oxide on the substrate. The temperature of the heating step can be controlled to control the morphology of the catalytic coating which may, for example, impact coke abatement performance. For example, as discussed below, a duration of the heating step and the temperature of the heating step may be sufficient to form metal oxide enriched crystallites and noble metal enriched crystallites that are homogenously distributed throughout the catalytic coating or have a layered morphology.

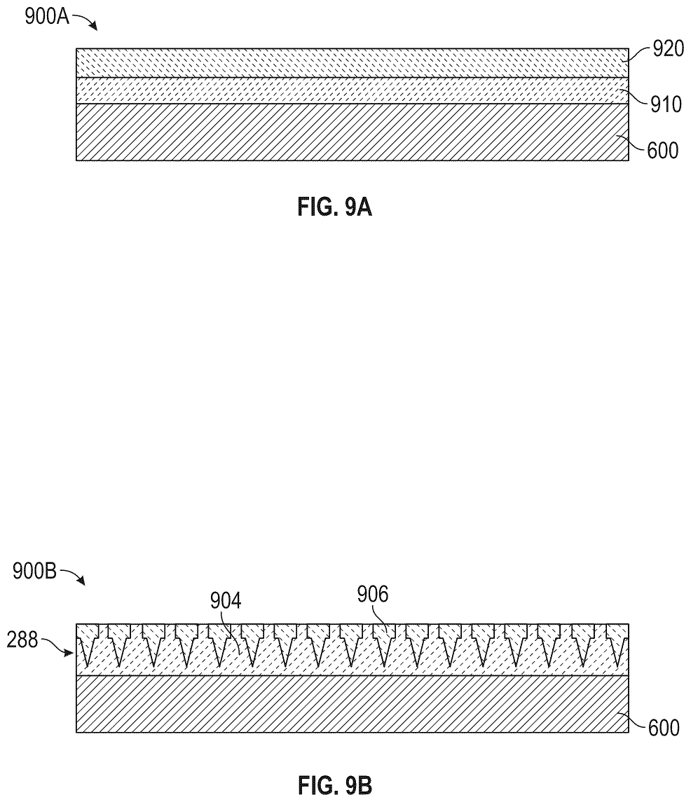

FIGS. 9A and 9B illustrate a process for forming the catalytic coating 288 discussed herein. As noted above, the catalytic coating 288 may be formed by applying one or more layers. FIG. 9A depicts a coated component 900A having a plurality of layers of the materials used to form catalytic coating 288 deposited on the substrate 600. These layers are referred to herein a precursor layers. More specifically, as shown in FIG. 9A, the process includes depositing a metal oxide layer 910 on the substrate 600 and depositing a noble metal layer 920 on the metal oxide layer 910. The coating then may be heat treated to result in the coated component 900B having the catalytic coating 288 depicted in FIG. 9B. The heating step forms noble metal enriched regions (e.g., 906) on top of a metal oxide enriched region 904 by, for example, fusing particles in the precursor layers to form crystallites. The noble metal enriched regions (e.g., 906) and the metal oxide enriched region 904 may have an irregular shape that depends on the crystalline structure of the material. The irregular shape may have a higher surface area of gran boundaries that can improve catalytic performance. FIG. 9B depicts a plurality of noble metal enriched regions on top of a single metal oxide enriched region. Other morphologies are possible such as a single noble metal enriched region in contact with a single metal oxide enriched region as well as the other nonlimiting morphologies discussed below.

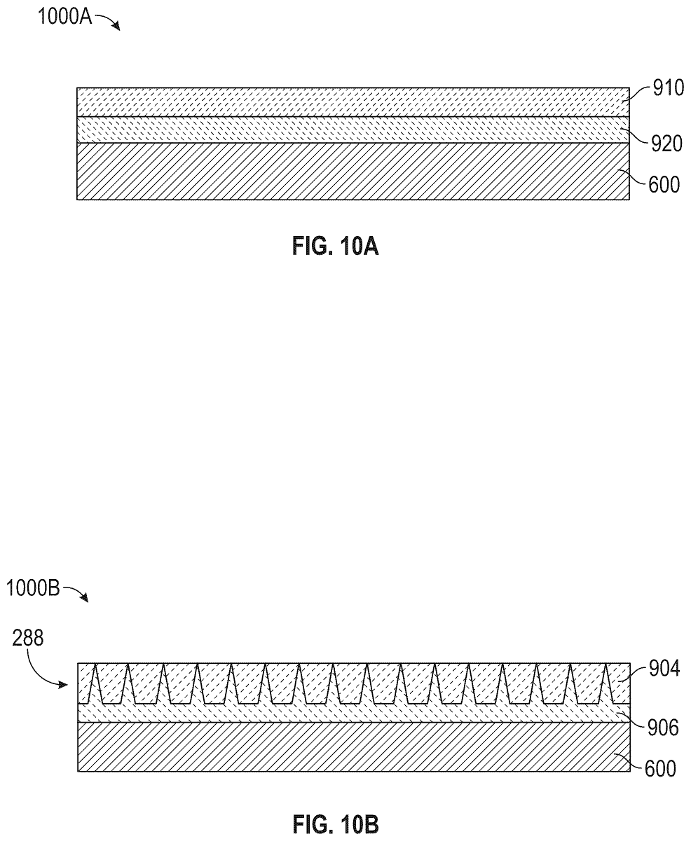

FIG. 9A is one arrangement of the plurality of precursor layers used to form the catalytic coating 288 discussed herein. Other arrangements and numbers of layers may be used, however. FIGS. 10A, 11A, 12A, 13A, and 14A depict additional arrangements of the precursor layers, and FIGS. 10B, 11B, 12B, 13B and 14B, respectively, depict the catalytic coating 288 after heat treatment of the corresponding precursor layers. The coated components depicted in FIGS. 10A to 14B are similar to those discussed above with reference to FIGS. 9A and 9B. The same reference numerals are used to refer to the same or similar components or features and a detailed description of these components and features is omitted here.

FIGS. 10A and 10B illustrate another process for forming the catalytic coating 288 discussed herein. In FIG. 9A, the metal oxide layer 910 is deposited first on the substrate 600 and the noble metal layer 920 is deposited on top of the metal oxide layer 910. This process can be reversed, and FIG. 10A depicts a coated component 1000A that is the inverse of the arrangement of the coated component 900A in FIG. 9A. Having a different layer on top can impact, for example, the catalytic activity or durability of the catalytic coating 288 by, for example, impacting a depth profile of crystallites in the catalytic layer. In FIG. 10A, the noble metal layer 920 is deposited on the substrate 600 and the metal oxide layer 910 is deposited on the noble metal layer 920. The coating in FIG. 10A can be heat treated to provide, e.g., a coated component 1000B having the catalytic coating 288. The heating step forms a noble metal enriched region 906 below a metal oxide enriched region 904. FIG. 10B depicts a single noble metal enriched region in contact with a plurality of single metal oxide enriched regions. Other morphologies are possible such as a plurality of noble metal enriched regions and/or a plurality of metal oxide enriched region as well as the other nonlimiting morphologies discussed below.

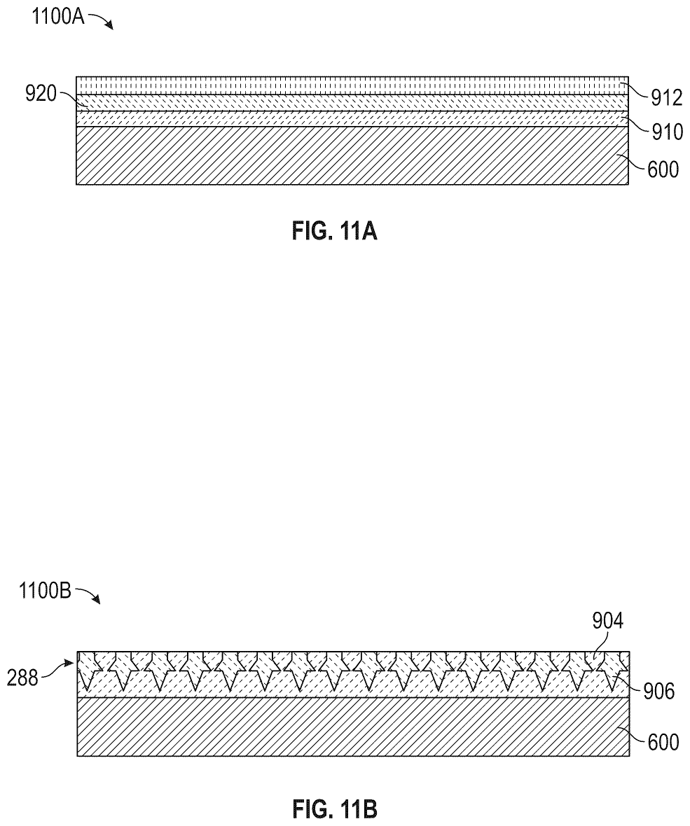

FIGS. 11A and 11B illustrate another process for forming the catalytic coating 288 discussed herein. In FIGS. 9A and 10A, a single metal oxide layer and a single noble metal layer is used as the precursor layers, but a plurality of metal oxide layers, a plurality of noble metal layers, or both may be used as the precursor layers. FIG. 11A includes a plurality of metal oxide layers. Each metal oxide layer may have the same or different chemical composition. Having multiple layers, e.g., as depicted in FIGS. 11A and 11B, can increase an interfacial area at boundaries between the plurality of metal oxide layers and the plurality of noble metal layers. Having an increased interfacial area can improve catalytic performance by, for example, increasing the number of catalytically active sites in the catalytic coating 288. In FIG. 11A, the metal oxide layer 910 is deposited first on the substrate 600, the noble metal layer 920 is deposited on top of the metal oxide layer 910, and the metal oxide layer 912 is deposited on top of the noble metal layer 920. The coating in FIG. 11A can be heat treated to provide, e.g., a coated component 1100B having the catalytic coating 288. The heating step forms noble metal enriched regions (e.g., 906) at least partially surrounded by the metal oxide enriched region 904, and, as depicted in FIG. 11B, the noble metal enriched regions (e.g., 906) are separated by the metal oxide enriched region 904. The noble metal enriched regions (e.g., 906) are shown as extending to the surface of the catalytic coating 288, but heat treatment to form other morphologies where the noble metal enriched regions (e.g., 906) are surrounded by the metal oxide enriched region 904 may be formed. FIG. 11B depicts a plurality of noble metal enriched regions in contact with a single metal oxide enriched region.

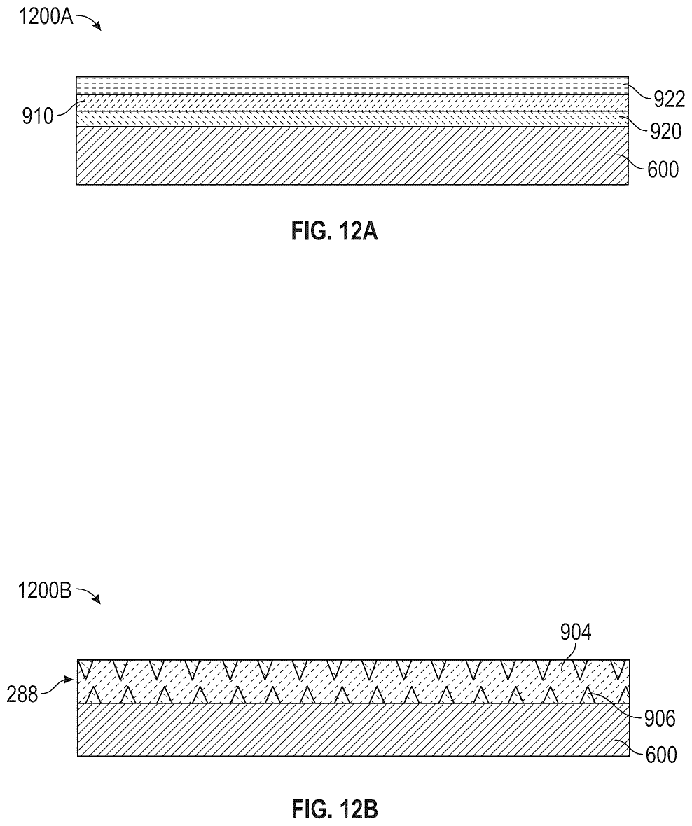

FIGS. 12A and 12B illustrate another process for forming the catalytic coating 288 discussed herein. FIG. 12A includes a plurality of noble metal layers, and FIG. 12A depicts a coated component 1200A that is the inverse of the arrangement of the coated component 1100A in FIG. 11A. As discussed above, inverting the arrangement of layers in the catalytic coating 288 can impact, for example, the catalytic activity or durability of the catalytic coating 288 by, for example, impacting a depth profile of crystallites in the catalytic layer. In FIG. 12A, the noble metal layer 920 is deposited first on the substrate 600, the metal oxide layer 910 is deposited on top of the noble metal layer 920, and the noble metal layer 922 is deposited on top of the metal oxide layer 910. The coating in FIG. 12A can be heat treated to provide a coated component 1200B having the catalytic coating 288. The heating step forms, e.g., metal oxide enriched regions (e.g., 904) at least partially surrounded by the noble metal enriched region 906, such as the metal oxide enriched regions (e.g., 904) depicted in FIG. 12B, or any of the other morphologies discussed herein. FIG. 12B depicts a single metal oxide enriched region in contact with a plurality of noble metal enriched regions.

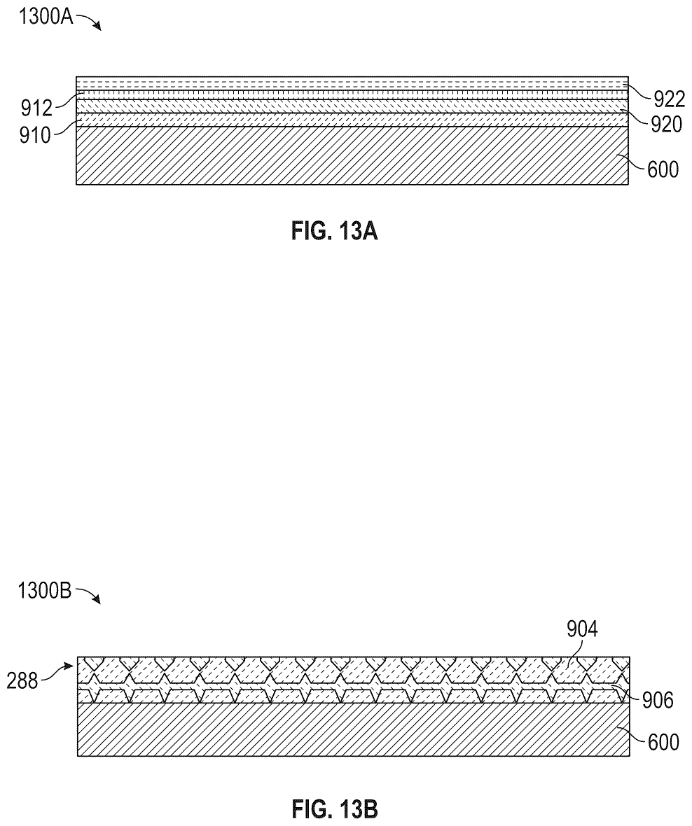

FIGS. 13A and 13B illustrate another process for forming the catalytic coating 288 discussed herein. Here, both a plurality of metal oxide layers and a plurality of noble metal layers are used. FIG. 13A depicts two layers of metal oxide and two layers of noble metal in an alternating arrangement. As discussed above, having more layers for any given thickness increases the interfacial area at boundaries between the plurality of metal oxide layers and the plurality of noble metal layers. An increased interfacial area can improve catalytic performance by, for example, increasing the number of catalytically active sites in the catalytic coating 288. In FIG. 13A, the metal oxide layer 910 is deposited first on the substrate 600, the noble metal layer 920 is deposited on top of the metal oxide layer 910, the metal oxide layer 912 is deposited on top of the noble metal layer 920, and the noble metal layer 922 is deposited on top of the metal oxide layer 912. The coating in FIG. 13A can be heat treated to provide a coated component 1300B having the catalytic coating 288. The heating step forms, e.g., noble metal enriched regions (e.g., 906) at least partially surrounded by the metal oxide enriched region 904. For example, in FIG. 13B, the noble metal enriched region 906 is layered beneath the metal oxide enriched region 904. FIG. 13B depicts a plurality of noble metal enriched regions on top of a single metal oxide enriched region that is layered on top of a single noble metal enriched region that is on top of a plurality metal oxide enriched regions.

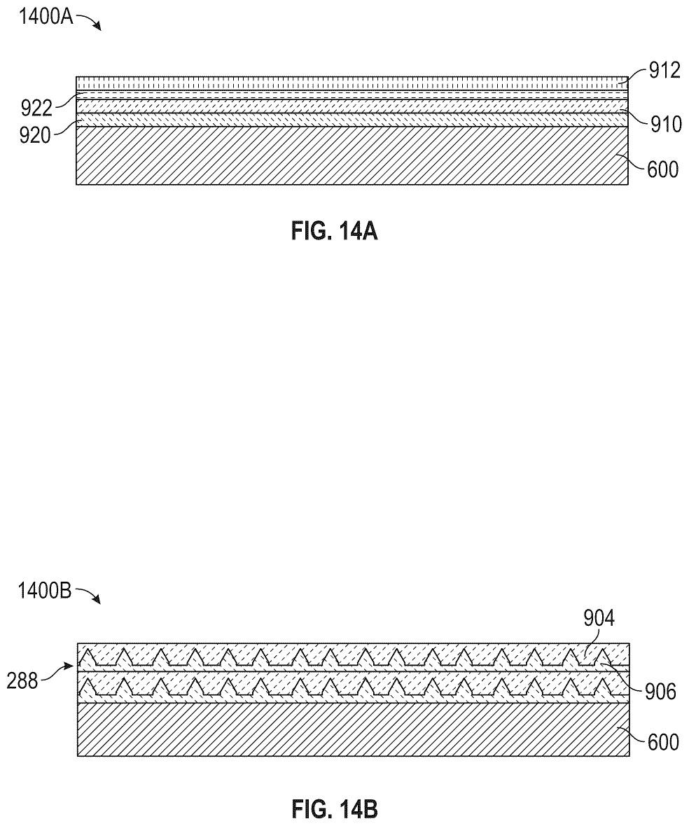

FIGS. 14A and 14B illustrate another process for forming the catalytic coating 288 discussed herein. FIG. 14A depicts a coated component 1400A that is the inverse of the arrangement of the coated component 1300A in FIG. 13A. As discussed above, inverting the arrangement of layers in the catalytic coating 288 can impact, for example, the catalytic activity or durability of the catalytic coating 288 by, for example, impacting a depth profile of crystallites in the catalytic layer. In FIG. 14A, the noble metal layer 920 is deposited first on the substrate 600, the metal oxide layer 910 is deposited on top of the noble metal layer 920, the noble metal layer 922 is deposited on top of the metal oxide layer 910, and the metal oxide layer 912 is deposited on top of noble metal layer 922. The coating in FIG. 14A can be heat treated to provide a coated component 1400B having the catalytic coating 288. The heating step forms, e.g., noble metal enriched regions (e.g., 906) at least partially surrounded by metal oxide enriched regions (e.g., 904), for example, in FIG. 14B the noble metal enriched region 906 and the metal oxide enriched region 904 are layered. FIG. 13B depicts two metal oxide enriched regions and two noble metal enriched regions in a layered arrangement.

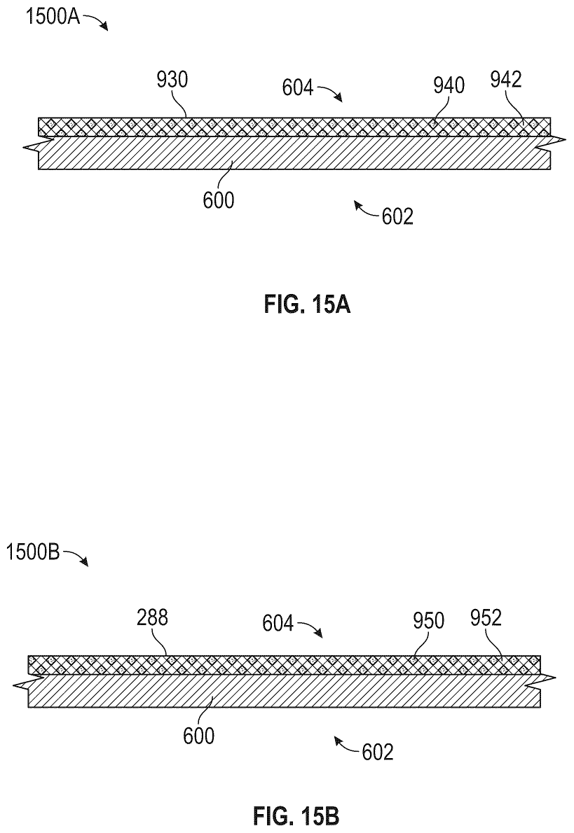

FIGS. 15A and 15B illustrate another process for forming the catalytic coating 288 discussed herein. In FIG. 15A, a precursor layer 930 is deposited first on the substrate 600 to form the coated component 1500A. The precursor layer 930 may contain a blend of metal oxide particles 940 and noble metal particles 942. The coating in FIG. 14A can be heat treated to provide a coated component 1500B having the catalytic coating 288. The heating step forms metal oxide enriched crystallites 950 and noble metal enriched crystallites 952 that are homogenously distributed throughout the catalytic coating 288. How crystallites are distributed throughout the catalytic coating can impact performance. For example, homogenously distributing the metal oxide enriched crystallites 950 and the noble metal enriched crystallites 952 throughout the catalytic coating 288 can provide the catalytic coating 288 with a more isotropic mechanical stress-strain or thermal expansion behavior.

Comparing FIGS. 9B, 10B, 11B, 12B, 13B, and 14B, it is believed that the architecture of the catalytic coating 288 can be controlled by the relative arrangements of the one or more noble metal layers 920 and the one or more metal oxide layer 900 deposited on the substrate 600 as depicted in FIGS. 9A, 10A, 11A, 12A, 13A, and 14A.

The inventors surprisingly found that catalyst compositions including a metal oxide enriched region having an average crystallite size with a diameter ranging from three nanometers to eighty nanometers and a noble metal enriched region having an average crystallite size with a diameter ranging from ten nanometers to one thousand nanometers provided superior coke abatement as compared to catalyst compositions that did not have this morphology. Without wishing to be bound by theory, it is believed that the microstructure of this morphology enhances coke abatement by, for example, increasing charge transfer across catalyst-coke interface (e.g., owing to increased interface between metal oxide and noble metal enriched regions), increasing the availability of catalytically active sites at phase boundaries and/or increasing the number of catalytically active defect sites within the catalyst composition. As an example, the inventors have found that a Co₃O₄ with ten weight percent Ag catalyst composition had a carbon oxidation initiation temperature increase from about four hundred and twenty degrees Fahrenheit to about four hundred and sixty degrees Fahrenheit when the catalyst particles are allowed to sinter, with an increase in final heat-treatment temperature from two hundred and forty-eight degrees Fahrenheit to one thousand one hundred and twelve degrees Fahrenheit. The choice of appropriate grain size and the aspect ratio of the two phases can enhance contact points between the two phases, thus improving the catalytic activity of the composition.

The crystallite size and porosity of the metal oxide enriched region may be controlled to adjust coke abatement performance. The crystallite size and porosity may impact coke abatement performance by, for example, increasing the availability of catalytically active sites at phase boundaries and/or increasing the number of catalytically active defect sites within the catalytic coating. In some embodiments, the metal oxide enriched region has the average crystallite diameter ranging from twenty nanometers to five hundred nanometers.

The metal oxide enriched region may have various morphologies and the morphology of the metal oxide enriched region may impact coke abatement performance by, for example, increasing the availability of catalytically active sites at phase boundaries, effecting the selectivity of a catalytically active site, effecting the reactivity of a catalytically active site, and/or increasing the number of catalytically active defect sites within the catalytic coating. In some embodiments, the metal oxide enriched region includes a plurality of metal oxide enriched crystallites having an average crystallite size with a diameter ranging from ten nanometers to one thousand nanometers.

The metal oxide enriched region may contain various amounts of the metal oxide. The amount of metal oxide in the metal oxide enriched region may impact coke abatement performance by, for example, increasing the availability of catalytically active sites, increasing the reactivity of the catalytically active sites, increasing the selectivity of the catalytically active sites, and/or increasing the number of catalytically active sites within the catalytic coating. The metal oxide enriched region may contain from fifty weight percent to one hundred weight percent of the metal oxide by total weight of the metal oxide enriched region. For example, the metal oxide enriched region may contain from sixty weight percent to one hundred weight percent of the metal oxide by total weight of the metal oxide enriched region, the metal oxide enriched region may contain from seventy weight percent to one hundred weight percent of the metal oxide by total weight of the metal oxide enriched region, the metal oxide enriched region may contain from eighty weight percent to one hundred weight percent of the metal oxide by total weight of the metal oxide enriched region, or the metal oxide enriched region may contain from ninety weight percent to one hundred weight percent of the metal oxide by total weight of the metal oxide enriched region.

The metal oxide in the metal oxide enriched region may be of formula (I) AₓE_{y}L_{z}MOᵤ. In formula (I), A is one or more alkaline earth elements chosen from beryllium, magnesium, calcium, strontium, and barium; x ranges from zero to one; E is one or more alkali metals chosen from lithium, sodium, potassium, rubidium, and cesium; y ranges from zero to one; L is one or more lanthanide elements chosen from lanthanum, cerium, praseodymium, neodymium, samarium, europium, gadolinium, terbium, dysprosium, holmium, erbium, thulium, ytterbium, and lutetium; z ranges from zero to one; M is one or more elements chosen from scandium, titanium, vanadium, chromium, manganese, iron, cobalt, nickel, copper, zinc, yttrium, zirconium, niobium, molybdenum, ruthenium, rhodium, palladium, silver, cadmium, lanthanum, hafnium, tantalum, tungsten, rhenium, osmium, iridium, platinum, gold, mercury, aluminum, gallium, indium, thallium, tin, lead, bismuth, carbon, nitrogen, fluorine, phosphorus, sulfur, chlorine, selenium, bromine, iodine, boron, silicon, germanium, arsenic, antimony, and tellurium; O is oxygen; and u ranges from 0.95 to six.

Different metal oxides of formula (I) may have different reactivities and/or selectivities for catalyzing reactions that degrade coke. In some embodiments, u ranges from 0.95 to three. In some embodiments, A is barium or strontium. In some embodiments, E is lithium, sodium, or potassium. In some embodiments, L is lanthanum, cerium, praseodymium, neodymium, samarium, gadolinium, or ytterbium. In some embodiments, and M is scandium, titanium, vanadium, chromium, manganese, iron, cobalt, nickel, copper, zinc, yttrium, zirconium, niobium, molybdenum, tungsten, aluminum, gallium, indium, thallium, tin, lead, silicon, or germanium. In some embodiments, the metal oxide is one or more composition chosen from Co₃O₄, NiₓCo₃₋ₓO₄, FeₓCo₃₋ₓO₄, CuₓCo₃₋ₓO₄, CrₓCo₃₋ₓO₄, Pr₆O₁₁, LiMn₂O₄, Al₂O₃, PbO, Pb₁₋ₓSrₓCoO₃, Pb₁₋ₓBaₓCoO₃, SrCoOᵤ, BaCoOᵤ, LnₓA₁₋ₓCoOᵤ, Sr_{0.8}Pr_{0.2}CoO₃, Ba_{0.8}Ce_{0.2}CoO₃, Ba_{0.8}Pr_{0.2}CoO₃, LnₓCa_{y}Sr_{z}Ba_{[1-(x+y+z)]}CoO₃, LnₓLi_{y}Sr_{z}Ba_{[1-(x+y+z)]}CoO₃, a cobaltite, a manganite, a chromite, a ferrite perovskite, xMoO₃-yCo₃O₄-zLi₂O, MₓE_{y}Co_{3-(x+y)}Oᵤ, MₓE_{y}A_{z}Co_{3-(x+y+z)}Oᵤ, Mn₂O₃, Mn₃O₄, Mn₂O₇, Mn doped TiO₂, Fe₂O₃, Fe₃O₄, ZnFe₂O₄, BiₓSn₁₋ₓOᵤ, InₓSn_{y}O_{z}, Bi₂O₃—Co₃O₄, and CeO₂. The metal oxide enriched region may include an amount of noble metal. The noble metal may include the same noble metal that is enriched in the noble metal enriched region and/or may include a noble metal different from the noble metal that is enriched in the noble metal enriched region. For example, the metal oxide may be doped with a noble metal.

The crystallite size of the noble metal enriched region may be controlled to adjust coke abatement performance. The crystallite size may impact coke abatement performance by, for example, increasing charge transfer across catalyst-coke interface, and/or increasing the availability of catalytically active sites at phase boundaries and/or increasing the number of catalytically active defect sites within the catalytic coating. In some embodiments, the noble metal enriched region has the average crystallite size with the diameter ranging from twenty nanometers to five hundred nanometers.

The noble metal enriched region may have various morphologies and the morphology of the noble metal enriched region may impact coke abatement performance by, for example, increasing the availability of catalytically active sites at phase boundaries and/or increasing the number of catalytically active defect sites within the catalytic coating. In some embodiments, the noble metal enriched region includes a plurality of noble metal enriched crystallites having an average crystallite size with a diameter ranging from ten nanometers to one thousand nanometers.

The noble metal enriched region may contain various amounts of the noble metal. The amount of noble metal in the noble metal enriched region may impact coke abatement performance by, for example, increasing the availability of catalytically active sites, increasing the reactivity of the catalytically active sites, and/or increasing the number of catalytically active sites within the catalytic coating. The noble metal enriched region may contain from fifty weight percent to one hundred weight percent of the noble metal by total weight of the noble metal enriched region. For example, the noble metal enriched region may contain from sixty weight percent to one hundred weight percent of the noble metal by total weight of the noble metal enriched region, the noble metal enriched region may contain from seventy weight percent to one hundred weight percent of the noble metal by total weight of the noble metal enriched region, the noble metal enriched region may contain from eighty weight percent to one hundred weight percent of the noble metal by total weight of the noble metal enriched region, or the noble metal enriched region may contain from ninety weight percent to one hundred weight percent of the noble metal by total weight of the noble metal enriched region. In some embodiments, the noble metal concentration in the catalytic coating, as a whole, ranges from 0.01 weight percent to thirty weight percent. For example, the noble metal concentration in the catalytic coating as a whole may range from five weight percent to twenty weight percent.

The distribution of the metal oxide enriched region and the noble metal enriched region may impact coke abatement performance. Different distributions of the metal oxide enriched region and the noble metal enriched region include, for example, a homogenous distribution of the metal oxide enriched region and the noble metal enriched region in the catalytic coating, a heterogenous distribution of the metal oxide enriched region and the noble metal enriched region in the catalytic coating, and a distribution having one or more layers of the metal oxide enriched region and one or more layers of the noble metal enriched region in the catalytic coating. For example, the metal oxide enriched region may include one or more layers having a plurality of metal oxide enriched crystallites having an average crystallite size with a diameter ranging from ten nanometers to one thousand nanometers and the noble metal enriched region may include one or more layers having a plurality of noble metal enriched crystallites having an average crystallite size with a diameter ranging from ten nanometers to one thousand nanometers. As an additional example, the metal oxide enriched region may include a plurality of metal oxide enriched crystallites having an average crystallite size with a diameter ranging from ten nanometers to one thousand nanometers, the noble metal enriched region may include a plurality of noble metal enriched crystallites having an average crystallite size with a diameter ranging from ten nanometers to one thousand nanometers, and the metal oxide enriched crystallites and noble metal enriched crystallites may be distributed throughout the catalytic coating. In some embodiments, the metal oxide enriched crystallites and noble metal enriched crystallites are homogenously distributed throughout the catalytic coating.

The crystallites of the metal oxide and/or the noble metal may have various morphologies. For example, the crystallites may be nano whiskers, nanowires, nano rods, nanoplates, and/or may have an oriented growth of the crystallite. The morphology of the crystallites may impact catalytic performance by, for example, having a different number and/or activity of various catalytically active sites.

As discussed above, the catalytic coating may be effective for coke abatement and may be used in various methods, for example, for oxidizing coke. In some embodiments, a method of oxidizing coke includes contacting the coke with the catalytic coating at a temperature ranging from three hundred degrees Fahrenheit to one thousand one hundred degrees Fahrenheit such that the coke is selectively oxidized by the catalytic coating in the presence of a hydrocarbon fuel.

### EXAMPLES

Specific embodiments will be demonstrated by reference to the following examples. These examples are disclosed solely by way of illustrating the present disclosure and should not be taken in any way to limit the scope of the present disclosure.

Example one: A catalytic composition in powder form containing the metal oxide Co₃O₄ and ten weight percent of the noble metal silver was prepared according to the following procedure: Co₃O₄ powder (less than fifty nanometer particle size) was mixed with a silver paste containing eighty weight percent silver particles having a D50 of two hundred nanometers, twenty weight percent silver particles having a D50 of two hundred to five thousand nanometer, and α-terpineol. The mixture was sonicated in ethanol at ninety-five to one hundred ten degrees Fahrenheit for forty minutes, dried in oven at two hundred twelve degrees Fahrenheit and heated at two hundred forty-eight degrees Fahrenheit for about twelve hours in a furnace.

The catalyst composition had a nano structured morphology with fifteen to thirty nanometer size crystallites. The optical basicity of the oxide host component of catalytic coating of example one was about 0.97 and the carbon oxidation initiation temperature was about four hundred twenty-degrees Fahrenheit. The oxidation initiation temperature for typical autoxidation coke formed from Jet A fuel can be about fifty degrees Fahrenheit lower than that for carbon.

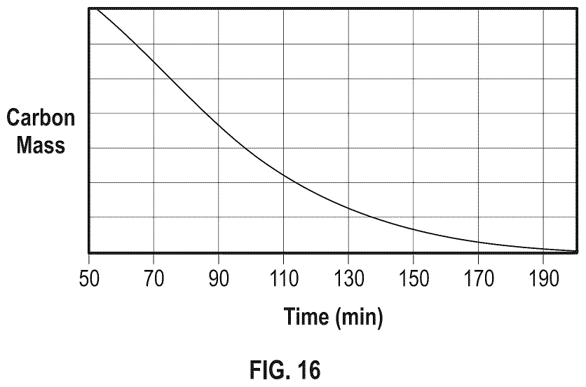

FIG. 16 shows the carbon mass loss with time at five hundred degrees Fahrenheit for the catalytic coating of example one in contact with carbon.

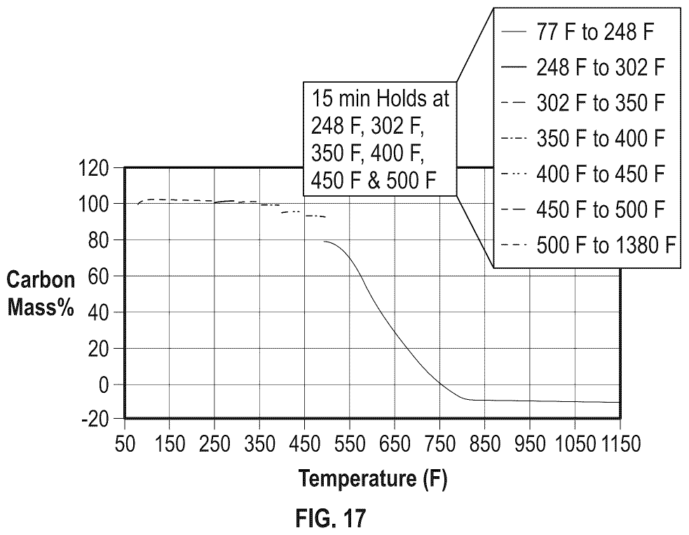

FIG. 17 shows the carbon mass loss with time at various temperatures during fifteen minute isothermal holds for the catalytic coating of example one in contact with carbon.

A catalyst composition similar to that in example one was coated on an Inconel® 625 substrate or a stainless steel substrate by chemical bath deposition. A solution of cobalt nitrate hexahydrate, silver nitrate (weight taken as per a deposition composition Co₃O₄ with twenty weight percent silver) and urea was prepared. Metal alloy substrates were immersed in this solution using a SS316 sample hanger and heated at one hundred ninety-four degrees Fahrenheit for about one to four hours (as per desired deposition thickness). Then the samples were removed from the chemical bath and heated in furnace at seven hundred fifty two degrees Fahrenheit for thirty minutes to achieve the coatings. The coated components were tested using the following procedure. A controlled amount of jet-A fuel per cycle was dropped onto the coated component. The coated component was then cyclically heated and cooled. The cyclical heating involved a four hundred fifty degree Fahrenheit maximum temperature, sixty minute holds at four hundred fifty degree Fahrenheit every cycle, and cooled to one hundred fifty degree Fahrenheit before the whole cycle is repeated. These cycles are repeated eighteen times. The covering gas had ten volume percent oxygen with balance nitrogen. This heating program allows the fuel to boil off every cycle leaving behind heavy molecular weight fuel oxidation products (e.g., coke) behind.

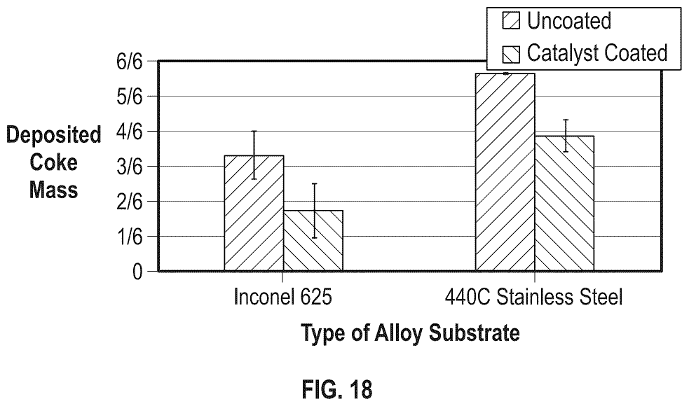

FIG. 18 compares the amount of deposited coke on coated components to that of uncoated control samples. As seen in FIG. 18, there was a forty seven percent reduction in deposited coke mass observed on the catalyst-coated Inconel® 625 and a thirty one percent reduction in deposited coke mass observed on the catalyst-coated stainless steel as compared to each respective uncoated control.

Example two: A catalyst composition (powder) containing the metal oxide Bi_{0.1}Sn_{0.9}O_{2-d} (where d was about 0.03) and ten weight percent of the noble metal silver was prepared according to the following procedure: SnCl₂·2H₂O and Bi(NO₃)₃·5H₂O was dissolved separately in about two hundred and fifty mL water acidified with five to ten mL of concentrated HNO₃. Then, liquor NH₃ (twenty-five to thirty percent) was added to each solution with stirring to obtain the metal hydroxide precipitates. The two precipitates along with corresponding liquid components were mixed and stirred, with addition of additional water. Then, the solid phase was separated from the liquid phase by centrifugation. Additional liquor NH₃ was added to the liquid phase after centrifugation to ensure complete precipitation of hydroxides. Centrifugation was carried out again to collect the solids. The clear liquid part was discarded. The solid phase was washed with water and ethanol and heat-treated in furnace to one thousand one hundred twelve degrees Fahrenheit for ten hours to obtain Bi_{0.1}Sn_{0.9}O_{2-d}. This was then mixed with silver paste containing eighty weight percent silver particles having a D50 of two hundred nanometers, twenty weight percent silver particles having a D50 of two hundred to five thousand nanometer, and α-terpineol. The mixture was sonicated in ethanol at ninety-five to one hundred ten degrees Fahrenheit for forty minutes, dried in oven at two hundred twelve degrees Fahrenheit and heated in furnace at three hundred ninety-two degrees Fahrenheit for about two hours to obtain the final catalyst powder.

The catalytic powder had a nano structured morphology. The estimated crystallite size of the oxide component is about 10 nm as per the X-ray diffraction pattern. The optical basicity of the oxide host component of the catalyst composition of example two was about 0.88 and the carbon oxidation initiation temperature was about four hundred fifty-degrees Fahrenheit.

Example three: A catalyst composition (powder) containing the metal oxide ZnFe₂O₄ and ten weight percent of the noble metal silver was prepared according to the following procedure: Metal nitrate precursors Zn(NO₃)₂·6H₂O and Fe(NO₃)₃·9H₂O were dissolved in minimum volume water. To this mixed solution of metal nitrates, citric acid was added (two to one molar ratio of citric acid to the metal cations) with stirring and further addition of water to obtain a clear solution. The solution was heated on a hot plate, initially at one hundred seventy six to one hundred ninety four degrees Fahrenheit for about an hour, and then at two hundred forty eight to three hundred twenty degrees Fahrenheit for nearly ten hours with monitoring. During this heating, as the water content of the solution decreased, the viscosity of the solution increased, and a gel was formed. The gel was allowed to dry on the hot plate at temperatures less than or equal to three hundred twenty degrees Fahrenheit. This was then placed in a furnace and heated up to nine hundred thirty two to one thousand one hundred twelve degrees Fahrenheit to obtain ZnFe₂O4 nanopowder. This was then mixed with silver paste containing eighty weight percent silver particles having a D50 of two hundred nanometers, twenty weight percent silver particles having a D50 of two hundred to five thousand nanometer, and α-terpineol. The mixture was sonicated in ethanol at ninety five to one hundred ten degrees Fahrenheit for forty minutes, dried in oven at two hundred twelve degrees Fahrenheit and heated in furnace at three hundred ninety-two degrees Fahrenheit for about two hours to obtain the final product.

The catalytic composition had a nano structured morphology with thirty nanometer to seventy nanometer size crystallites. The optical basicity of the oxide host component of the catalyst composition of example three was about 0.8 and the carbon oxidation initiation temperature was about four hundred seventy-six degrees Fahrenheit. The oxidation initiation temperature for typical autoxidation coke formed from Jet A fuel can be about fifty degrees Fahrenheit lower than that for carbon. The increased particle size and decreased optical basicity increases the carbon/coke oxidation initiation temperature in this case compared to the earlier example.

Without wishing to be bound by theory, it is believed that the microstructure of this morphology enhances coke abatement by, for example, increasing charge transfer across catalyst-coke interface (e.g., owing to increased interface between metal oxide and noble metal enriched regions), increasing the availability of catalytically active sites at phase boundaries and/or increasing the number of catalytically active defect sites within the catalyst composition.

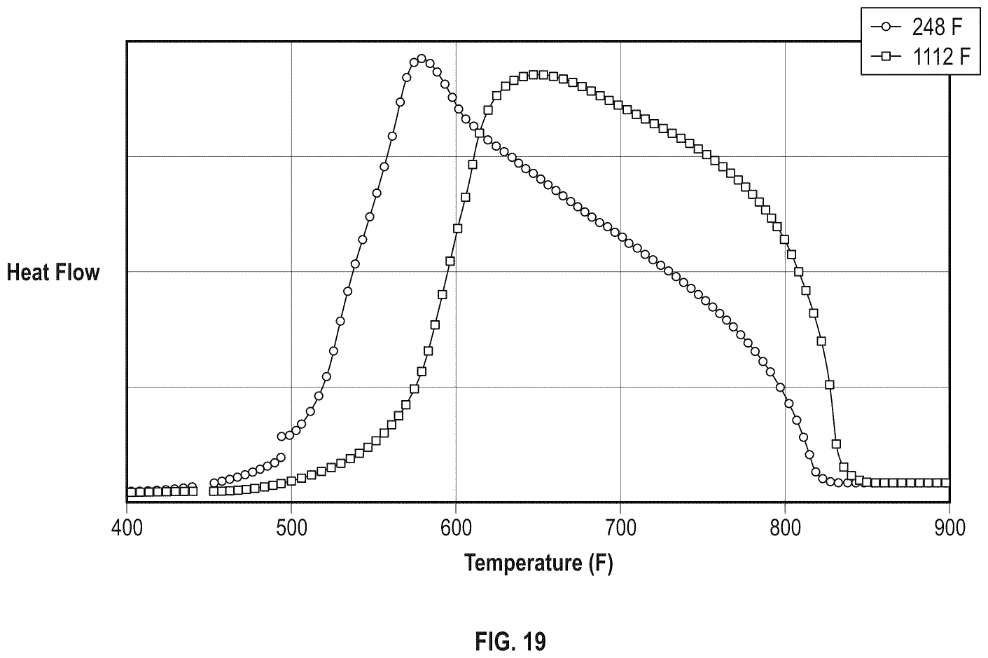

FIG. 19 depicts heat flow data for a Co₃O₄ with ten weight percent Ag catalyst composition showing that the coke oxidation initiation temperature increases from about four hundred twenty degrees Fahrenheit to about four hundred sixty degrees Fahrenheit when the catalyst particles are allowed to sinter, with an increase in final heat-treatment temperature from two hundred forty-eight degrees Fahrenheit to one thousand one hundred twelve degrees Fahrenheit. The inventors believe that the one thousand one hundred twelve degree Fahrenheit heat treatment makes the catalyst material lose the nano-crystalline structure resulting in increased carbon/coke oxidation initiation temperature.

As discussed above, the catalytic coating may be effective for coke abatement and may be applied to various components such as aircraft components and/or gas turbine engine components.

Further aspects of the present disclosure are provided by the subject matter of the following clauses.

A coated component for coke abatement in a gas turbine engine, the coated component including a substrate; and a catalytic coating on the substrate. The catalytic coating includes a metal oxide enriched region having an average crystallite size with a diameter ranging from three nanometers to eighty nanometers wherein the metal oxide enriched region is enriched in a metal oxide of formula AₓE_{y}L_{z}MOᵤ and a noble metal enriched region having an average crystallite size with a diameter ranging from ten nanometers to one thousand nanometers In formula AₓE_{y}L_{z}MOᵤ, A is one or more alkaline earth elements chosen from beryllium, magnesium, calcium, strontium, and barium; x ranges from zero to one; E is one or more alkali metals chosen from lithium, sodium, potassium, rubidium, and cesium; y ranges from zero to one; L is one or more lanthanide elements chosen from lanthanum, cerium, praseodymium, neodymium, samarium, europium, gadolinium, terbium, dysprosium, holmium, erbium, thulium, ytterbium, and lutetium; z ranges from zero to one; M is one or more elements chosen from scandium, titanium, vanadium, chromium, manganese, iron, cobalt, nickel, copper, zinc, yttrium, zirconium, niobium, molybdenum, ruthenium, rhodium, palladium, silver, cadmium, lanthanum, hafnium, tantalum, tungsten, rhenium, osmium, iridium, platinum, gold, mercury, aluminum, gallium, indium, thallium, tin, lead, bismuth, carbon, nitrogen, fluorine, phosphorus, sulfur, chlorine, selenium, bromine, iodine, boron, silicon, germanium, arsenic, antimony, and tellurium; O is oxygen; u ranges from 0.95 to six.

The coated component of the preceding clause, such that A is barium or strontium, E is lithium, sodium, or potassium, L is lanthanum, cerium, praseodymium, neodymium, samarium, gadolinium, or ytterbium, and M is scandium, titanium, vanadium, chromium, manganese, iron, cobalt, nickel, copper, zinc, yttrium, zirconium, niobium, molybdenum, tungsten, aluminum, gallium, indium, thallium, tin, lead, silicon, or germanium.

The coated component of any of the preceding clauses, such that the metal oxide is one or more composition chosen from Co₃O₄, NiₓCo₃₋ₓO₄, FeₓCo₃₋ₓO₄, CuₓCo₃₋ₓO₄, CrₓCo₃₋ₓO₄, Pr₆O₁₁, LiMn₂O₄, Al₂O₃, PbO, Pb₁₋ₓSrₓCoO₃, Pb₁₋ₓBaₓCoO₃, SrCoOᵤ, BaCoOᵤ, LnₓA₁₋ₓCoOᵤ, Sr_{0.8}Pr_{0.2}CoO₃, Ba_{0.8}Ce_{0.2}CoO₃, Ba_{0.8}Pr_{0.2}CoO₃, LnₓCa_{y}Sr_{z}Ba_{[1-(x+y+z)]}CoO₃, LnₓLi_{y}Sr_{z}Ba_{[1-(x+y+z)]}CoO₃, a cobaltite, a manganite, a chromite, a ferrite perovskite, xMoO₃-yCo₃O₄-zLi₂O, MₓE_{y}Co_{3-(x+y)}Oᵤ, MₓE_{y}A_{z}Co_{3-(x+y+z)}Oᵤ, Mn₂O₃, Mn₃O₄, Mn₂O₇, Mn doped TiO₂, Fe₂O₃, Fe₃O₄, ZnFe₂O₄, BiₓSn₁₋ₓOᵤ, InₓSn_{y}O_{z}, Bi₂O₃—Co₃O₄, and CeO₂.

The coated component of any of the preceding clauses, such that the metal oxide enriched region includes an amount of a noble metal.

The coated component of any of the preceding clauses, such that the diameter of the average crystallite size of the metal oxide enriched region ranges from twenty nanometers to five hundred nanometers and the diameter of the average crystallite size of the noble metal enriched region ranges from twenty nanometers to five hundred nanometers.

The coated component of any of the preceding clauses, such that the metal oxide has an optical basicity ranging from 0.8 to 1.95.

The coated component of any of the preceding clauses, such that wherein the catalytic coating includes a plurality of metal oxide enriched regions, wherein each of the plurality of metal oxide enriched regions is a crystallite having a diameter ranging from ten nanometers to one thousand nanometers; a plurality of noble metal enriched regions, wherein each of the plurality of noble metal enriched regions is a crystallite having a diameter ranging from ten nanometers to one thousand nanometers; and wherein the plurality of metal oxide enriched regions and the plurality of noble metal enriched regions are distributed throughout the catalytic coating.

The coated component of any of the preceding clauses, such that the catalytic coating includes two or more metal oxide enriched regions each having an average crystallite size with a diameter ranging from ten nanometers to one thousand nanometers wherein each metal oxide enriched region is enriched in a metal oxide of formula AₓE_{y}L_{z}MOᵤ; and two or more noble metal enriched regions each having an average crystallite size with a diameter ranging from ten nanometers to one thousand nanometers.

The coated component of any of the preceding clauses, such that the catalytic coating includes two or more metal oxide enriched regions each having an average crystallite size with a diameter ranging from ten nanometers to one thousand nanometers wherein each metal oxide enriched region is enriched in a metal oxide of formula AₓE_{y}L_{z}MOᵤ; and two or more noble metal enriched regions each having an average crystallite size with a diameter ranging from ten nanometers to one thousand nanometers, and the two or more metal oxide enriched regions are in a layered arrangement with the two or more noble metal enriched regions.

The coated component of any of the preceding clauses, such that the substrate is a metal substrate, a ceramic substrate, a metal substrate coated with a ceramic layer, or a ceramic substrate coated with a metal layer.

The coated component of any of the preceding clauses, such that the substrate is a metal substrate chosen from iron-based alloys, nickel-based alloys, cobalt-based alloys, alloys containing cobalt and chromium, alloys containing platinum and aluminum, alloys containing nickel and aluminum, and alloys containing nickel, chromium, aluminum, and yttrium.

The coated component of any of the preceding clauses, such that the coated component is a gas turbine engine component.

The coated component of any of the preceding clauses, such that the coated component is an aircraft component chosen from a fluid passage, a nozzle, a valve orifice, a vane, a pilot orifice, a main orifice, a valve, a swirler, a venturi, a heat exchanger, an aft heat shield, and a lube oil system component.

The coated component of any of the preceding clauses, such that the catalytic coating has a thickness ranging from 0.02 micron to ten microns.

The coated component of any of the preceding clauses, such that the substrate is a metal substrate coated with a ceramic layer and the ceramic layer is a thermal barrier coating.

The coated component of any of the preceding clauses, such that the substrate is a metal substrate coated with a ceramic layer and the ceramic layer is a thermal barrier coating including (ZrO₂)_{(1-q)}(Y₂O₃)_{q}, wherein q ranges from 0.04 to 0.5.

The coated component of any of the preceding clauses, such that u ranges from 0.95 to three.

A method of oxidizing coke, the method including contacting the coke with the coated component of any of the preceding clauses at a temperature ranging from three hundred degrees Fahrenheit to one thousand one hundred degrees Fahrenheit, wherein the coke is selectively oxidized by the catalytic coating in the presence of a hydrocarbon fuel.

A method of making the coated component of any of the preceding clauses, the method including at least one metal oxide depositing step, wherein the metal oxide of formula AₓE_{y}L_{z}MOᵤ is deposited as a metal oxide layer; at least one noble metal depositing step, wherein the noble metal is deposited as a noble metal layer; and a heating step at a temperature ranging from three hundred degrees Fahrenheit to one thousand seven hundred degrees Fahrenheit, wherein the heating step occurs after the at least one metal oxide depositing step and after the at least one noble metal depositing step, wherein one of the at least one noble metal depositing step deposits the noble metal on the substrate or one of the at least one metal oxide depositing step deposits the metal oxide on the substrate.

The method of the preceding clause, such that a duration of the heating step and the temperature of the heating step are sufficient to form metal oxide enriched crystallites and noble metal enriched crystallites that are homogenously distributed throughout the catalytic coating.

A catalytic coating including a metal oxide enriched region having an average crystallite size with a diameter ranging from three nanometers to eighty nanometers and a noble metal enriched region having an average crystallite size with a diameter ranging from ten nanometers to one thousand nanometers. The metal oxide enriched region is enriched in a metal oxide of formula AₓE_{y}L_{z}MOᵤ. In AₓE_{y}L_{z}MOᵤ, A is one or more alkaline earth elements chosen from beryllium, magnesium, calcium, strontium, and barium, x ranges from zero to one, E is one or more alkali metals chosen from lithium, sodium, potassium, rubidium, and cesium; y ranges from zero to one, L is one or more lanthanide elements chosen from lanthanum, cerium, praseodymium, neodymium, samarium, europium, gadolinium, terbium, dysprosium, holmium, erbium, thulium, ytterbium, and lutetium, z ranges from zero to one, M is one or more elements chosen from scandium, titanium, vanadium, chromium, manganese, iron, cobalt, nickel, copper, zinc, yttrium, zirconium, niobium, molybdenum, ruthenium, rhodium, palladium, silver, cadmium, lanthanum, hafnium, tantalum, tungsten, rhenium, osmium, iridium, platinum, gold, mercury, aluminum, gallium, indium, thallium, tin, lead, bismuth, carbon, nitrogen, fluorine, phosphorus, sulfur, chlorine, selenium, bromine, iodine, boron, silicon, germanium, arsenic, antimony, and tellurium, O is oxygen, u ranges from 0.95 to six.

The catalytic coating of the preceding clause, such that A is barium or strontium, E is lithium, sodium, or potassium, L is lanthanum, cerium, praseodymium, neodymium, samarium, gadolinium, or ytterbium, and M is scandium, titanium, vanadium, chromium, manganese, iron, cobalt, nickel, copper, zinc, yttrium, zirconium, niobium, molybdenum, tungsten, aluminum, gallium, indium, thallium, tin, lead, silicon, or germanium.

The catalytic coating of any of the preceding clauses, such that the metal oxide is one or more composition chosen from Co₃O₄, NiₓCo₃₋ₓO₄, FeₓCo₃₋ₓO₄, CuₓCo₃₋ₓO₄, CrₓCo₃₋ₓO₄, Pr₆O₁₁, LiMn₂O₄, Al₂O₃, PbO, Pb₁₋ₓSrₓCoO₃, Pb₁₋ₓBaₓCoO₃, SrCoOᵤ, BaCoOᵤ, LnₓA₁₋ₓCoOᵤ, Sr_{0.8}Pr_{0.2}CoO₃, Ba_{0.8}Ce_{0.2}CoO₃, Ba_{0.8}Pr_{0.2}CoO₃, LnₓCa_{y}Sr_{z}Ba_{[1-(x+y+z)]}CoO₃, LnₓLi_{y}Sr_{z}Ba_{[1-(x+y+z)]}CoO₃, a cobaltite, a manganite, a chromite, a ferrite perovskite, xMoO₃-yCo₃O₄-zLi₂O, MₓE_{y}Co_{3-(x+y)}Oᵤ, MₓE_{y}A_{z}Co_{3-(x+y+z)}Oᵤ, Mn₂O₃, Mn₃O₄, Mn₂O₇, Mn doped TiO₂, Fe₂O₃, Fe₃O₄, ZnFe₂O₄, BiₓSn₁₋ₓOᵤ, InₓSn_{y}O_{z}, Bi₂O₃—Co₃O₄, and CeO₂.

The catalytic coating of any of the preceding clauses, such that the metal oxide enriched region includes an amount of a noble metal.

The catalytic coating of any of the preceding clauses, such that the diameter of the average crystallite size of the metal oxide enriched region ranges from twenty nanometers to five hundred nanometers and the diameter of the average crystallite size of the noble metal enriched region ranges from twenty nanometers to five hundred nanometers.

The catalytic coating of any of the preceding clauses, such that the metal oxide has an optical basicity ranging from 0.8 to 1.95.

The catalytic coating of any of the preceding clauses, such that the catalytic coating includes a plurality of metal oxide enriched regions, wherein each of the plurality of metal oxide enriched regions is a crystallite having a diameter ranging from ten nanometers to one thousand nanometers, a plurality of noble metal enriched regions, wherein each of the plurality of noble metal enriched regions is a crystallite having a diameter ranging from ten nanometers to one thousand nanometers, and wherein the plurality of metal oxide enriched regions and the plurality of noble metal enriched regions are distributed throughout the catalytic coating.

The catalytic coating of any of the preceding clauses, such that the catalytic coating includes two or more metal oxide enriched regions each having an average crystallite size with a diameter ranging from ten nanometers to one thousand nanometers wherein each metal oxide enriched region is enriched in a metal oxide of formula AₓE_{y}L_{z}MOᵤ, and two or more noble metal enriched regions each having an average crystallite size with a diameter ranging from ten nanometers to one thousand nanometers.

The catalytic coating of any of the preceding clauses, such that the two or more metal oxide enriched regions are in a layered arrangement with the two or more noble metal enriched regions.

A coated component including the catalytic coating of any of the preceding clauses coated on a substrate.

The coated component of the preceding clause, such that the substrate is a metal substrate, a ceramic substrate, a metal substrate coated with a ceramic layer, or a ceramic substrate coated with a metal layer.

The coated component of any of the preceding clauses, such that the substrate is a metal substrate chosen from iron-based alloys, nickel-based alloys, cobalt-based alloys, alloys containing cobalt and chromium, alloys containing platinum and aluminum, alloys containing nickel and aluminum, and alloys containing nickel, chromium, aluminum, and yttrium.

The coated component of any of the preceding clauses, such that the coated component is a gas turbine engine component.

The coated component of any of the preceding clauses, such that the coated component is an aircraft component chosen from a fluid passage, a nozzle, a valve orifice, a vane, a pilot orifice, a main orifice, a valve, a swirler, a venturi, a heat exchanger, an aft heat shield, and a lube oil system component.

The coated component of any of the preceding clauses, such that the catalytic coating has a thickness ranging from 0.02 micron to ten microns.

The coated component of any of the preceding clauses, such that the substrate is a metal substrate coated with a ceramic layer and the ceramic layer is a thermal barrier coating.

The coated component of any of the preceding clauses, such that the thermal barrier coating includes (ZrO₂)_{(1-q)}(Y₂O₃)_{q}, wherein q ranges from 0.04 to 0.5.

A method of oxidizing coke, the method including contacting the coke with the catalytic coating of any of the preceding clauses at a temperature ranging from three hundred degrees Fahrenheit to one thousand one hundred degrees Fahrenheit, wherein the coke is selectively oxidized by the catalytic coating in the presence of a hydrocarbon fuel.

A method of making the coated component of any of the preceding clauses, the method including at least one metal oxide depositing step, wherein the metal oxide of formula AₓE_{y}L_{z}MOᵤ is deposited as a metal oxide layer; at least one noble metal depositing step, wherein the noble metal is deposited as a noble metal layer; and a heating step at a temperature ranging from three hundred degrees Fahrenheit to one thousand seven hundred degrees Fahrenheit, wherein the heating step occurs after the at least one metal oxide depositing step and after the at least one noble metal depositing step, wherein one of the at least one noble metal depositing step deposits the noble metal on the substrate or one of the at least one metal oxide depositing step deposits the metal oxide on the substrate.

The method of the preceding clause, such that a duration of the heating step and the temperature of the heating step are sufficient to form metal oxide enriched crystallites and noble metal enriched crystallites that are homogenously distributed throughout the catalytic coating.

Although the foregoing description is directed to some exemplary embodiments of the present disclosure, other variations and modifications will be apparent to those skilled in the art, and may be made without departing from the disclosure. Moreover, features described in connection with one embodiment of the present disclosure may be used in conjunction with other embodiments, even if not explicitly stated above.

1. A coated component for coke abatement in a gas turbine engine, the coated component comprising:
a substrate; and
a catalytic coating on the substrate, the catalytic coating including:
a metal oxide enriched region having an average crystallite size with a diameter ranging from three nanometers to eighty nanometers wherein the metal oxide enriched region is enriched in a metal oxide of formula AₓE_{y}L_{z}MOᵤ wherein:
A is one or more alkaline earth elements chosen from beryllium, magnesium, calcium, strontium, and barium; x ranges from zero to one; E is one or more alkali metals chosen from lithium, sodium, potassium, rubidium, and cesium; y ranges from zero to one; L is one or more lanthanide elements chosen from lanthanum, cerium, praseodymium, neodymium, samarium, europium, gadolinium, terbium, dysprosium, holmium, erbium, thulium, ytterbium, and lutetium; z ranges from zero to one; M is one or more elements chosen from scandium, titanium, vanadium, chromium, manganese, iron, cobalt, nickel, copper, zinc, yttrium, zirconium, niobium, molybdenum, ruthenium, rhodium, palladium, silver, cadmium, lanthanum, hafnium, tantalum, tungsten, rhenium, osmium, iridium, platinum, gold, mercury, aluminum, gallium, indium, thallium, tin, lead, bismuth, carbon, nitrogen, fluorine, phosphorus, sulfur, chlorine, selenium, bromine, iodine, boron, silicon, germanium, arsenic, antimony, and tellurium; O is oxygen; u ranges from 0.95 to 6; and
a noble metal enriched region having an average crystallite size with a diameter ranging from ten nanometers to one thousand nanometers.

2. The coated component of claim 1, wherein A is barium or strontium, E is lithium, sodium, or potassium, L is lanthanum, cerium, praseodymium, neodymium, samarium, gadolinium, or ytterbium, and M is scandium, titanium, vanadium, chromium, manganese, iron, cobalt, nickel, copper, zinc, yttrium, zirconium, niobium, molybdenum, tungsten, aluminum, gallium, indium, thallium, tin, lead, silicon, or germanium.

3. The coated component of claim 1, wherein the metal oxide is one or more composition chosen from Co₃O₄, NiₓCo₃₋ₓO₄, FeₓCo₃₋ₓO₄, CuₓCo₃₋ₓO₄, CrₓCo₃₋ₓO₄, Pr₆O₁₁, LiMn₂O₄, Al₂O₃, PbO, Pb₁₋ₓSrₓCoO₃, Pb₁₋ₓBaₓCoO₃, SrCoOᵤ, BaCoOᵤ, LnₓA₁₋ₓCoOᵤ, Sr_{0.8}Pr_{0.2}CoO₃, Ba_{0.8}Ce_{0.2}CoO₃, Ba_{0.8}Pr_{0.2}CoO₃, LnₓCa_{y}Sr_{z}Ba_{[1-(x+y+z)]}CoO₃, LnₓLi_{y}Sr_{z}Ba_{[1-(x+y+z)]}CoO₃, a cobaltite, a manganite, a chromite, a ferrite perovskite, xMoO₃-yCo₃O₄-zLi₂O, MₓE_{y}Co_{3-(x+y)}Oᵤ, MₓE_{y}A_{z}Co_{3-(x+y+z)}Oᵤ, Mn₂O₃, Mn₃O₄, Mn₂O₇, Mn doped TiO₂, Fe₂O₃, Fe₃O₄, ZnFe₂O₄, BiₓSn₁₋ₓOᵤ, InₓSn_{y}O_{z}, Bi₂O₃—Co₃O₄, and CeO₂.

4. The coated component of claim 1, wherein the metal oxide enriched region comprises an amount of a noble metal.

5. The coated component of claim 1, wherein the diameter of the average crystallite size of the metal oxide enriched region ranges from twenty nanometers to five hundred nanometers and the diameter of the average crystallite size of the noble metal enriched region ranges from twenty nanometers to five hundred nanometers.

6. The coated component of claim 1, wherein the metal oxide has an optical basicity ranging from 0.8 to 1.95.

7. The coated component of claim 1, wherein the catalytic coating comprises:
a plurality of metal oxide enriched regions, wherein each of the plurality of metal oxide enriched regions is a crystallite having a diameter ranging from ten nanometers to one thousand nanometers; and
a plurality of noble metal enriched regions, wherein each of the plurality of noble metal enriched regions is a crystallite having a diameter ranging from ten nanometers to one thousand nanometers,
wherein the plurality of metal oxide enriched regions and the plurality of noble metal enriched regions are distributed throughout the catalytic coating.

8. The coated component of claim 1, wherein the catalytic coating comprises:
two or more metal oxide enriched regions each having an average crystallite size with a diameter ranging from ten nanometers to one thousand nanometers wherein each metal oxide enriched region is enriched in a metal oxide of formula AₓE_{y}L_{z}MOᵤ; and
two or more noble metal enriched regions each having an average crystallite size with a diameter ranging from ten nanometers to one thousand nanometers.

9. The coated component of claim 1, wherein the catalytic coating comprises:
two or more metal oxide enriched regions each having an average crystallite size with a diameter ranging from ten nanometers to one thousand nanometers wherein each metal oxide enriched region is enriched in a metal oxide of formula AₓE_{y}L_{z}MOᵤ; and
two or more noble metal enriched regions each having an average crystallite size with a diameter ranging from ten nanometers to one thousand nanometers,
wherein the two or more metal oxide enriched regions are in a layered arrangement with the two or more noble metal enriched regions.

10. The coated component of claim 1, wherein the substrate is a metal substrate, a ceramic substrate, a metal substrate coated with a ceramic layer, or a ceramic substrate coated with a metal layer.

11. The coated component of claim 1, wherein the substrate is a metal substrate chosen from iron-based alloys, nickel-based alloys, cobalt-based alloys, alloys containing cobalt and chromium, alloys containing platinum and aluminum, alloys containing nickel and aluminum, and alloys containing nickel, chromium, aluminum, and yttrium.

12. The coated component of claim 1, wherein the coated component is a gas turbine engine component.

13. The coated component of claim 1, wherein the coated component is an aircraft component chosen from a fluid passage, a nozzle, a valve orifice, a vane, a pilot orifice, a main orifice, a valve, a swirler, a venturi, a heat exchanger, an aft heat shield, and a lube oil system component.

14. The coated component of claim 1, wherein the catalytic coating has a thickness ranging from 0.02 micron to ten microns.

15. The coated component of claim 1, wherein the substrate is a metal substrate coated with a ceramic layer and the ceramic layer is a thermal barrier coating.

16. The coated component of claim 1, wherein the substrate is a metal substrate coated with a ceramic layer and the ceramic layer is a thermal barrier coating comprising (ZrO₂)_{(1-q)}(Y₂O₃)_{q}, wherein q ranges from 0.04 to 0.5.

17. The coated component of claim 1, wherein u ranges from 0.95 to three.

18. A method of oxidizing coke, the method comprising:
contacting the coke with the coated component of claim 1 at a temperature ranging from three hundred degrees Fahrenheit to one thousand one hundred degrees Fahrenheit,
wherein the coke is selectively oxidized by the catalytic coating in the presence of a hydrocarbon fuel.

19. A method of making the coated component of claim 1, the method comprising:
at least one metal oxide depositing step, wherein the metal oxide of formula AₓE_{y}L_{z}MOᵤ is deposited as a metal oxide layer;
at least one noble metal depositing step, wherein the noble metal is deposited as a noble metal layer; and
a heating step at a temperature ranging from three hundred degrees Fahrenheit to one thousand seven hundred degrees Fahrenheit, wherein the heating step occurs after the at least one metal oxide depositing step and after the at least one noble metal depositing step,
wherein one of the at least one noble metal depositing step deposits the noble metal on the substrate or one of the at least one metal oxide depositing step deposits the metal oxide on the substrate.

20. The method of claim 19, wherein a duration of the heating step and the temperature of the heating step are sufficient to form metal oxide enriched crystallites and noble metal enriched crystallites that are homogenously distributed throughout the catalytic coating.
